(19) United States
(12) Patent Application Publication
(10) Pub. No.: US 2015/0180964 A1
(43) Pub. Date: Jun. 25, 2015

(54) INFORMATION PROCESSING APPARATUS AND LOAD TEST METHOD

(71) Applicant: FUJITSU LIMITED, Kawasaki-shi (JP)

(72) Inventor: Nobuaki SASAKI, Setagaya (JP)

(73) Assignee: FUJITSU LIMITED, Kawasaki (JP)

(21) Appl. No.: 14/638,802

(22) Filed: Mar. 4, 2015

Related U.S. Application Data
(63) Continuation of application No. PCT/JP2012/074296, filed on Sep. 21, 2012.

(51) Int. Cl. H04L 29/08; H04L 12/26

(52) U.S. Cl. CPC H04L 67/101; H04L 43/0882

(57) ABSTRACT

An information processing apparatus includes a transmission unit, a reception unit and a processor. The transmission unit transmits a packet. The reception unit receives a packet. The processor measures a load ratio, which is a usage rate of a band between the transmission unit and the reception unit, when the transmission unit is transmitting the packet to the reception unit. Then, the processor sequentially adjusts a plurality of parameters whose changes insetting lead to changes in the load ratio, in descending order of influence on an increase/decrease in the load ratio in such a manner that the measured load ratio becomes closer to a determined load ratio.

### CROSS-REFERENCE TO RELATED APPLICATION

This application is a continuation application of International Application PCT/JP2012/074296 filed on Sep. 21, 2012, and designated U.S., the entire contents of which are incorporated herein by reference.

### FIELD

The embodiments discussed herein are related to a technique of adjusting loads on a network.

### BACKGROUND

High load tests, which examine the operation stability of a computer apparatus by forcing the computer apparatus to perform high-load processes, are widely practiced. One such high load test conducted on a computer apparatus is a network load test, which tests whether or not a computer apparatus operates normally with loads applied to the network of the computer apparatus. In some cases, a network load test is conducted by using a computer apparatus in a stand-alone state. In such a case, each port of a network card of the computer apparatus is connected by a LAN (Local Area Network) cable. In this situation, the computer apparatus transmits and receives packets within the same apparatus so as to apply loads to the network and thereby conducts a load test.

As a related art, the following technique is known. A calculation system provides a line adapter with a unit that detects the mounting of a loopback connector. The calculation system conducts an adapter test when a loopback connector is not mounted, and conducts a line test when a loopback connector is mounted. In a testing method of an electronic computer system, in which a test is conducted on hardware in a test environment appropriate to the configuration and operation mode of the electronic computer system, a piece of operation environment information for conducting a test is set for each test item. Then, a test program control unit that controls the test of the electronic computer reads system configuration information and operation mode information of the electronic computer system that have been set in advance, and also reads each piece of operation environment information. The test program control unit compares the system configuration information and operation mode information of the electronic computer system with each piece of operation environment information and recognizes the test environment, and thereby determines whether or not to conduct a test so as to conduct tests on the corresponding test items. (For example, Japanese Laid-open Patent Publication No. 01-238250 and Japanese Laid-open Patent Publication No. 06-012275)

In the load test technique described above, when for example a packet count value or the number of connections, which are set when packets are transmitted and received by the transmission side and the reception side of computer apparatuses, are insufficient, loads are not imposed on the network between the transmission side and the reception side. Also, when a packet count value or the number of connections is increased too much, loads applied to a control circuit of a computer apparatus become heavy and it becomes impossible for the control circuit to transmit or receive as many packets as specified, preventing loads from being applied to the network. Accordingly, in order to maximize network loads (also referred to as loads hereinafter), it is desirable to find parameters for adjusting the packet count value or the number of connections that lead to appropriate maximum loads on the resources of the computer apparatus.

However, computer apparatuses differ from each other in the number of CPUs included, memory sizes, the number of network cards, the number of network ports and network speeds. In other words, each computer apparatus has different resources that are available and different processing performance. Accordingly, in order to apply high network loads to each computer apparatus, it is desirable to set parameters (test settings) uniquely for each computer.

Further, with the increase in the speeds of networks attained in recent years, it sometimes occurs that insufficient resources of a computer apparatus prevent an increase in network loads. In order to increase network loads, processes such as adjustment of parameters, reviewing of control, confirmation of control, etc., are conducted. Because of this, it takes much labor and time to increase network loads. Also, confirmation of the setting of a computer apparatus involves several thousands to several tens of thousands of combinations of items to be confirmed, making it difficult to find the parameters that lead to the maximum network loads for each apparatus.

### SUMMARY

According to an aspect of the embodiments, an information processing apparatus includes a transmission unit, a reception unit and a processor. The transmission unit transmits a packet. The reception unit receives a packet. The processor measures a load ratio, which is a usage rate of a band between the transmission unit and the reception unit, when the transmission unit is transmitting the packet to the reception unit. Then, the processor sequentially adjusts a plurality of parameters whose changes in the setting lead to changes in the load ratio, in descending order of influence on an increase/decrease in the load ratio in such a manner that the measured load ratio becomes closer to a determined load ratio.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating an example of an information processing apparatus;

FIG. 2A, FIG. 2B and FIG. 2C illustrate examples of data in tables used in a load test;

FIG. 3 is a block diagram illustrating an example of the information processing apparatus;

FIG. 4 is a flowchart illustrating the content of a process of a load test;

FIG. 5 is a flowchart illustrating the content of an adjustment process for a buffer size;

FIG. 6 illustrates a flowchart of the content of an adjustment process for a packet count value;

FIG. 7 illustrates a flowchart of the content of an adjustment process for a packet count value;

FIG. 8 illustrates a flowchart illustrating the content of an adjustment process for a number of connections;

FIG. 9A and FIG. 9B are flowcharts illustrating the content of an adjustment process for a CPU bind count;

FIG. 10 is a flowchart illustrating the content of an adjustment process for a number of dispatch processes; and

FIG. 11 is a flowchart illustrating the content of an adjustment process for a priority level.

### DESCRIPTION OF EMBODIMENTS

Explanations will be given for an information processing apparatus of an embodiment.

The information processing apparatus includes at least one network card and at least two ports for transmitting and receiving packets. The information processing apparatus forms a port pair by connecting two arbitrary ports in a loopback manner with a LAN cable so as to transmit and receive packets. Also, the information processing apparatus measures the number of packets that are transmitted and received between the port pair and obtains the transfer rate (bytes/sec, for example) per unit time. Then, the information processing apparatus divides the transfer rate by a band so as to calculate the load ratio.

The information processing apparatus assigns resources for processes of transmitting or receiving packets for each port pair while monitoring the load ratio, and changes a plurality of parameters whose changes in the setting lead to changes in the load ratio so that as many communication bands as possible are used for communications between port pairs. In this adjustment, the information processing apparatus sequentially adjusts parameters in descending order of influence on an increase/decrease in the load ratio, among a plurality of parameters.

As described above, the information processing apparatus adjusts the setting of a plurality of parameters while monitoring the load ratio of each port pair, and thereby obtains the maximum load that can be output by the capacity of the information processing apparatus. Also, when adjusting the setting of a plurality of parameters, the information processing apparatus sequentially adjusts parameters in descending order of influence on an increase/decrease in the load ratio. Thereby, the information processing apparatus adjusts the network loads in a load test over a range from a rough level to a fine level so as to find the maximum value of the network load, and thereby can adjust the network load more efficiently than in a case where a plurality of combinations of parameters are used at random.

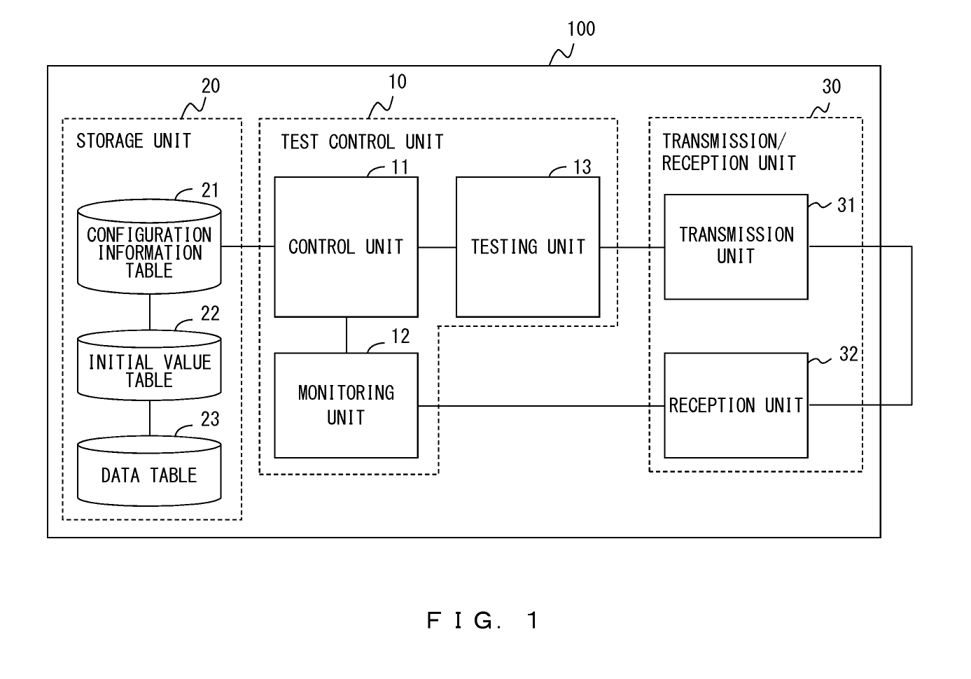

FIG. 1 is a functional block diagram illustrating an example of the information processing apparatus.

In FIG. 1, an information processing apparatus 100 includes a test control unit 10, a storage unit 20 and a transmission/reception unit 30. Hereinbelow, a network load test that uses the information processing apparatus 100 alone will be explained. Also, explanations will be given for a case where the information processing apparatus 100 finds the maximum network load that is determined by the resources of the information processing apparatus 100, the bands of LAN cables used for loopback connection, etc., in the adjustment of the network load. However, it is possible to implement the functions of one information processing apparatus 100 as a whole by using a plurality of information processing apparatuses that respectively bear some of the respective functions of the test control unit 10, the storage unit 20 and the transmission/reception unit 30 illustrated in FIG. 1. Also, the information processing apparatus 100 according to the embodiments may be configured to arbitrarily obtain a desired network load by adjusting a plurality of parameters so that the load ratio becomes closer to a load determined by a user instead of using the maximum network load. In the explanations below, it is assumed that the maximum network load is set as a determined load.

The test control unit 10 includes a control unit 11, a monitoring unit 12 and a testing unit 13. The test control unit 10 sequentially adjusts parameters in descending order of influence on an increase/decrease in the load ratio while monitoring the load ratio (load) measured by the monitoring unit 12 so that the load ratio becomes closer to the maximum load (determined load).

The control unit 11 changes the setting of a plurality of parameters so that the load ratio measured by the monitoring unit 12 becomes closer to the determined load ratio . Then, the control unit 11 sequentially adjusts parameters in descending order of influence on an increase/decrease in the load ratio when the setting of the plurality of parameters is to be changed.

When packets are being transmitted from a transmission unit 31 to a reception unit 32 included in the transmission/reception unit 30, the monitoring unit 12 measures the load ratio between the transmission unit 31 and the reception unit 32.

When a plurality of parameters set by the control unit 11 have been input, the testing unit 13 generates, in accordance with the setting of the plurality of input parameters, packets to be transmitted and received by the transmission/reception unit 30, and outputs the packets to the transmission/reception unit 30. More specifically, the testing unit 13 generates, in accordance with instructions from the control unit 11, as many packets as specified by a packet count value, which is a specified number of packets, by using specified resources, and the testing unit 13 outputs the generated packets to the transmission unit 31 so as to transmit the packets via the transmission unit 31 to the reception unit 32 each time the testing unit 13 generates the packets. Also, the testing unit 13 uses part of the region of the storage unit 20 as a transmission buffer of the transmission unit 31 and a reception buffer of the reception unit 32 in accordance with the setting conducted by the control unit 11. When there are a plurality of the transmission/reception units 30 that operate, the test control unit 10 includes one testing unit 13 for each of the transmission/reception units 30 that operate, although this configuration is not illustrated.

The storage unit 20 includes a configuration information table 21, an initial value table 22 and a data table 23.

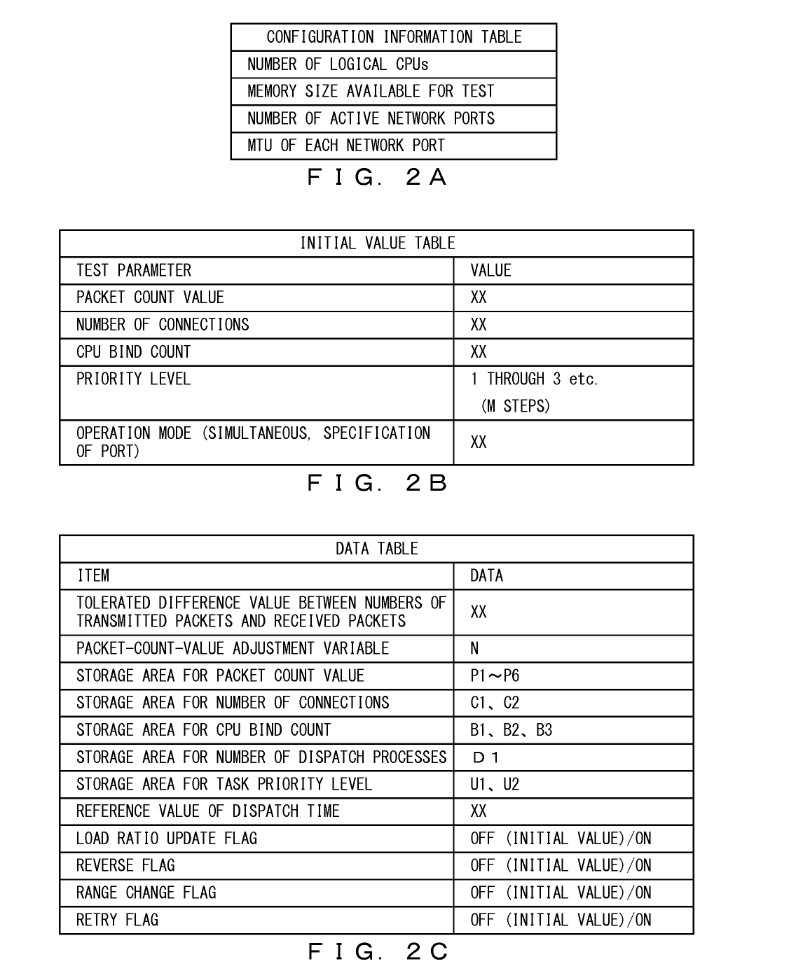

As illustrated in FIG. 2A, the configuration information table 21 stores the number of logical CPUs (Central Processing Units), the memory size available for the test, the number of active network ports and the MTU (Maximum Transmission Unit) of each network port.

A number of logical CPUs is the number of cores of CPUs included in the information processing apparatus 100. When a technique such as hyper threading is applied to the information processing apparatus 100 and one processor can also be treated as a plurality of processors, e.g., two processors, the logical number of such CPUs may be treated as the number of logical CPUs.

A memory size available for a test is the size of a storage area, in the memories included in the information processing apparatus 100, assigned to the load test.

A number of active network ports is the number of ports that are included in the network card included in the information processing apparatus 100. Note that a network card functions as the transmission/reception unit 30 and ports included in a network card function as the transmission unit 31 or the reception unit 32.

The MTU of each network port is a value representing the maximum value of data that can be transmitted in one transfer by each network port. For MTUs, values can be set on the network side for each network connection.

The initial value table 22 stores, as illustrated in FIG. 2B, the packet count value, the number of connections, the CPU bind count, the priority level and the value of the operation mode as parameters for a load test.

A packet count value is the number of packets that are generated by the testing unit 13, stored in a transmission buffer and transmitted to the reception unit 32 from the transmission unit 31 in one packet transmission process. In other words, the testing unit 13 generates packets, stores the generated packets in a transmission buffer and transmits the packets to the reception unit 32 via the transmission unit 31 each time as many packets as specified by the packet count value are generated.

A number of connections is the number of logical communication channels of packets between the transmission unit 31 and the reception unit 32. Because the information processing apparatus 100 transmits packets to as many communication channels as the number of connections, as many tasks related to transmission/reception of packets (referred to as a transmission/reception task hereinafter) as the number of connections are executed in parallel.

A CPU bind count is the number of logical CPUs assigned to each port pair. A CPU bind count is a number equal to or smaller than the number of logical CPUs that each port pair can use exclusively, and increases or decreases in accordance with the necessity of the processes of a load test.

A priority level is the priority level of a transmission/reception task in a dispatch process. Specifically, it is a priority level at which execution rights are assigned to transmission/reception tasks by the scheduler, and execution rights to execute processes corresponding to the number of dispatch processes are assigned to tasks in descending order of priority level. In other words, a priority level is a parameter that determines the order of executing transmission/reception tasks and other processes.

An operation mode is a mode that sets whether to make all ports operate simultaneously or to only make a specified port operate when the information processing apparatus 100 includes a plurality of ports. The information processing apparatus 100 does not have a large amount of resources and thus when all ports are made to operate simultaneously, it is sometimes impossible to apply a high load to the band of a port pair when a load test is conducted. In such a situation, it is possible for the information processing apparatus 100 to specify, in an operation mode, a port that is to operate so as to apply a high load to the specified port by conducting a load test. In such a case, a load test is conducted a plurality of times on each specified port in order to conduct a load test on all ports. In the following explanations, the operation mode will not be described particularly for simplicity. When the operation mode is taken into consideration, a load test may be conducted for each specified port.

As illustrated in FIG. 2C, the data table 23 stores the difference value of the numbers of transmitted/received packets, a variable for adjusting a packet count value, the storage area for a packet count value, the storage area for the number of connections, the storage area for the CPU bind count, the storage area for the number of dispatch processes, the storage area for a task priority level, a reference value of a dispatch time, a load ratio update flag, a reverse flag, a range change flag and a retry flag, and also stores data of these items.

The data table 23 stores respective pieces of data obtained when the information processing apparatus 100 adjusts parameter values for a load test. In an adjustment process for parameter values, adjusted values for parameter values are extracted from the storage areas for the respective parameters stored in the data table 23, on the basis of the results of the adjustment process for parameter values. Then, the information processing apparatus 100 uses adjusted values of a plurality of parameter values in a load test. Contents of the respective pieces of data will be described later in the explanations for the operations of the information processing apparatus 100.

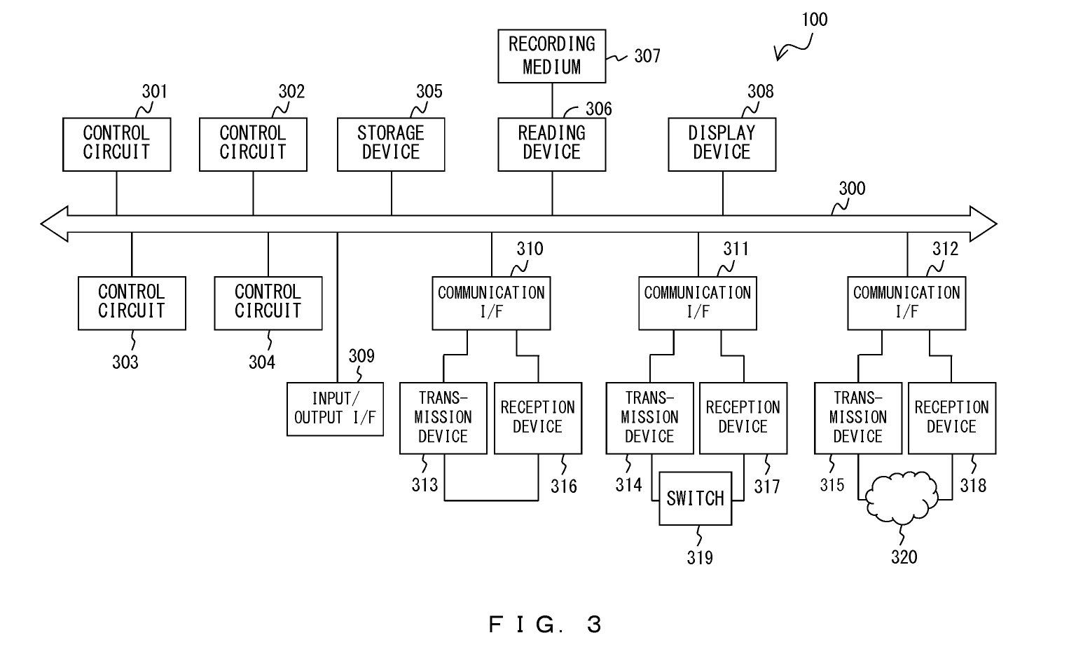

FIG. 3 is a block diagram illustrating an example of the information processing apparatus.

In FIG. 3, the information processing apparatus 100 includes control circuits 301 through 304, a storage device 305, a reading device 306, a recording medium 307, a display device 308, an input/output interface (input/output I/F) 309, communication interfaces (communication I/Fs) 310 through 312, transmission devices 313 through 315, reception devices 316 through 318, a switch 319 and a network 320. These respective constituents are connected to each other via a bus 300.

The control circuits 301 through 304 control the entirety of the information processing apparatus 100. The control circuits 301 through 304 are processors such as for example a CPU, a multicore CPU, an FPGA (Field Programmable Gate Array), a PLD (Programmable Logic Device), etc. The control circuits 301 through 304 function as the test control unit 10 in FIG. 1. Although this is not illustrated, the control circuits 301 through 304 may include storage areas such as registers so as to function as transmission buffers and reception buffers that are used by the transmission unit 31 and the reception unit 32. In the explanations below, “control circuit” refers to an arbitrary one of the control circuits 301 through 304. Also, while the information processing apparatus 100 includes four control circuits in FIG. 3, the number of control circuits may be an arbitrary number equal to or greater than one.

The storage device 305 stores various types of data. The storage device 305 is a non-transitory computer-readable recording medium such as for example a ROM (Read Only Memory), a RAM (Random Access Memory), etc., or an HD (Hard Disk), etc. The ROM stores a program such as a boot program, etc. The RAM is used as a work area for a control circuit. The HD stores programs such as an OS (Operating System), an application program, firmware, and various types of data. Also, the storage device 305 of the information processing apparatus 100 stores the configuration information table 21, the initial value table 22 and the data table 23 illustrated in FIG. 1. The configuration information table 21, the initial value table 22 and the data table 23 may be stored in a server connected in the network 320 when they can be accessed by a control circuit of the information processing apparatus 100 via the communication interface 312.

The storage device 305 of the information processing apparatus 100 stores a load test program for making a control circuit function as the test control unit 10. When a load test is started, a control circuit of the information processing apparatus 100 reads into the RAM the load test program stored in the storage device 305. Thereby, a control circuit of the information processing apparatus 100 uses the RAM as a work space so as to function as the test control unit 10. Also, the load test program may be stored in a server connected in the network 320 when it can be accessed by a control circuit in the information processing apparatus 100 via the communication interface 312.

When the storage device 305 is an HD, the HD is connected to the bus 300 via a HDD (Hard Disk Drive). Data is read from and written to the HD with the HDD controlled by a control circuit.

The reading device 306 is controlled by a control circuit and reads data from and writes data to the recording medium 307, which is detachable. The reading device 306 is for example an FDD (Floppy Disk Drive), a CDD (Compact Disc Drive), a DVDD (Digital Versatile Disk Drive), a BDD (Blu-ray Disk Drive: registered trademark), a USB (Universal Serial Bus), etc. Also, the reading device 306 of the information processing apparatus 100 may read a load test program stored in the recording medium 307 and store it in the storage device 305.

The recording medium 307 stores various types of data. As an example, the recording medium 307 stores a load test program. The recording medium 307 is connected to the bus 300 via the reading device 306, and data reading/writing is conducted with a control circuit controlling the reading device 306. Thereby, data stored in the recording medium 307 may be written to a storage device 402. The recording medium 307 is for example a non-transitory computer-readable recording medium such as an FD (Floppy Disk), a CD (Compact Disc), a DVD (Digital Versatile Disk), a BD (Blu-ray Disk: registered trademark), a flash memory, etc.

The display device 308 displays input information in the form of images so as to report such information to a user. The display device 308 is for example a CRT (Cathode Ray Tube), an LCD (Liquid Crystal Display), a PDP (Plasma Display Panel), an GELD (Organic Electroluminescence Display), etc. It is also possible to report input information to a user by lighting a lamp or by sound output from a speaker instead of using the display device 308. It is also possible to configure the display device 308 by using a touch panel so as to make the display device 308 function as an input device.

The input/output interface 309 is connected to for example a mechanical button, a keyboard, a mouse, a touch panel, a scanner, a printer, etc., and receives input of a signal that represents various types of information from a connected device. The input/output interface 309 outputs the input signal to a control circuit via the bus 300. Also, upon receiving input of a signal, via the bus 300, representing various types of information output from a control circuit, the input/output interface 309 outputs that signal to respective connected devices.

The communication interfaces 310 through 312 connect the information processing apparatus 100 to a different information processing apparatus 100 in such a manner that communication is possible via power line communication, a LAN cable, wireless communication or the network 320 such as the Internet.

The communication interfaces 310 through 312 of an embodiment are for example network cards, and each of them has a port. The communication interfaces 310 through 312 respectively provide loopback connections by using LAN cables and thereby form port pairs having transmission-side ports (transmission devices 313 through 315) and reception-side ports (reception devices 316 through 318). The communication interfaces 310 through 312 function as the transmission/reception unit 30 in FIG. 1. Also, in FIG. 1, the transmission devices 313 through 315 function as the transmission unit 31 in FIG. 1. Further, the reception devices 316 through 318 function as the reception unit 32 in FIG. 1. In the explanations below, it is assumed that “communication interface” refers to an arbitrary one of the communication interfaces 310 through 312. A case where the information processing apparatus 100 includes four communication interfaces is illustrated in FIG. 3, but the number of communication interfaces may be an arbitrary number equal to or greater than one. Also, methods of respectively connecting the transmission devices 313 through 315 and the reception devices 316 through 318 are not limited to a method that uses LAN cables, and for example power line communication or wireless communication may be employed.

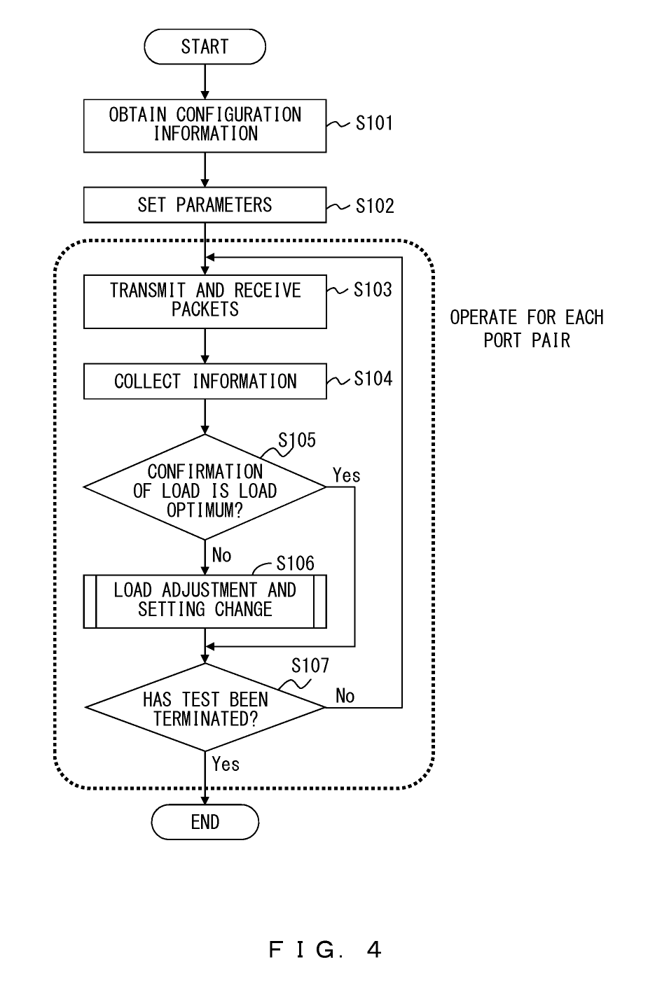

FIG. 4 is a flowchart illustrating the content of a process of a load test.

FIG. 4 illustrates the content of a process of an entire load test, including the start of the load test of the information processing apparatus 100, dynamic load adjustment and the end of the load test.

When a load test has been started, the control unit 11 obtains, from the configuration information table 21 illustrated in FIG. 2A, the number of logical CPUs included in the information processing apparatus 100, the memory size available for the test, the number of active network ports and the MTU of each network port. Further, the control unit 11 obtains the initial values of the packet count value, the number of connections, the CPU bind count, and the priority level, from the initial value table illustrated in FIG. 2B (S101).

The control unit 11 sets the number of logical CPUs used by the port pair and the buffer sizes of a transmission buffer used by a transmission-side port (the transmission unit 31) and a reception buffer used by a reception-side port (reception unit 32). Further, the control unit 11 sets the parameters to be output to the testing unit 13, such as the number of connections of the port pair, the packet count value of packets transmitted and received by the port pair, etc., to the initial values obtained in S101.

Specific explanations will be given for the assignment of resources and parameter setting in S102.

The control unit 11 divides by two the number of active network ports obtained in S101, and calculates the number of port pairs (transmission/reception units 30).

Also, the control unit 11 divides, by the number of port pairs, the number of logical CPUs included in the information processing apparatus 100, and thereby calculates the number of logical CPUs that one port pair can use exclusively. In other words, a number of logical CPUs that can be used exclusively is the maximum value that can be set as the CPU bind count in the setting of parameters. When only some of the number of logical CPUs included in the information processing apparatus 100 are assigned to a load test, the information processing apparatus 100 may calculate the number of logical CPUs that one port pair can use exclusively by dividing the number of assigned logical CPUs by the number of port pairs.

Further, the control unit 11 calculates the memory size available for one port pair (referred to as an assigned memory size hereinafter) by dividing a memory size available for a test by the number of network ports. Memory assigned to a port pair is referred to as assigned memory.

Then, the control unit 11 substitutes the values obtained in S101 into expressions (1) and (2) below so as to calculate the transmission-side memory size and the reception-side memory size, which are results of dividing the assigned memory size into the transmission side and the reception side.

When, for example, the division ratio between the transmission side and the reception side is M (ratio for the transmission side):N (ratio for the reception side), the following expressions are satisfied.

transmission-side memory size=assigned memory size×M/(M+N) (1)

reception-side memory size=assigned memory size×N/(M+N) (2)

Also, the control unit 11 substitutes the values obtained in S101 into expression (3) below so as to calculate the size of the storage area for the transmission buffer (referred to as the size of the transmission buffer).

transmission buffer size=packet count value×MTU of each port×the number of connections (3)

The control unit 11 sets the size of the storage area for the reception buffer (referred to as the size of the reception buffer hereinafter) to a value greater than the transmission buffer size. This is for the purpose of preventing overflows that would be caused when new packets are received from the transmission side before the process on packets received previously from the transmission side, which are processed after once being stored in the reception buffer on the reception side, has been terminated.

The control unit 11 sets the CPU bind count at the start of a load test as follows. When the initial value of the CPU bind count stored in the initial value table 22 is zero or the number of logical CPUs that can be used exclusively <1, the assignment of CPUs to port pairs is not conducted and one CPU is shared by a plurality of port pairs. Accordingly, when the number of logical CPUs that can be used exclusively <1, the control unit 11 sets nothing as the CPU bind count. When the CPU bind count>the number of logical CPUs that can be used exclusively, the CPU bind count is set to the number of logical CPUs that can be used exclusively. Other items are set to the values stored in the initial value table.

The control unit 11 outputs to the testing unit 13 the parameters set in S102. Then, the testing unit 13 generates a packet and transmits the packet to the reception unit 32 via the transmission unit 31 in accordance with the parameters input from the control unit 11. Thereby, the transmission/reception unit 30 transmits and receives packets (S103).

Specific explanations will be given for the transmission and reception of a packet in S103.

First, the testing unit 13 refers to the parameters received from the control unit 11 so as to execute the transmission/reception tasks for the results of multiplying the number of connections by the number of port pairs. Then, the testing unit 13 uses the CPUs assigned by the CPU binds and the assigned memories so as to make each transmission/reception task operate, and transmits packets each time as many packets as specified by the packet count value are generated. Also, a transmission/reception task executed by one port pair is further separated into two transmission/reception tasks in order to perform transmission and reception bi-directionally. These two transmission/reception tasks are classified into for example a task of transmitting a packet in the direction from port A to port B and a task of transmitting a packet in the direction from port B to port A. Note that in the embodiments, explanations will be given for an example where packet transmission is unidirectional for simplicity.

The monitoring unit 12 measures the number of packets being transmitted and received so as to calculate a transfer rate, which is the transmission amount of data per unit time. Then, the monitoring unit 12 calculates the load ratio (S104) by dividing the calculated transfer rate by a band between the transmission unit 31 and the reception unit 32. The band is determined by the configurations of the transmission-side port and the reception-side port, the shape of the LAN cable, etc., and for example may be stored in a storage area in the storage device 305 so as to be reported to the monitoring unit 12 via the control unit 11. Also, the processes in S101 through S104 are processes related to the processes in S105 and S106, which will be explained later in detail, and set the initial values of the respective parameters so as to calculate the load ratio in a case when the respective parameters are set to the initial values. Accordingly, the processes in S101 through S104 may be treated as processes in which when the control unit 11 has started changing one parameter, the set value of one parameter is set to the initial value, a packet is transmitted to the reception unit via the transmission unit and the monitoring unit 12 measures the load ratio.

The control unit 11 refers to the load ratio (measured load ratio) calculated by the monitoring unit 12 and determines whether or not the load has become the optimum load (S105). Whether or not a load ratio is optimum may be determined by whether or not the load ratio has reached a determined load. It is also possible to employ, as the optimum load, the maximum network load that can be covered by the capacity of the information processing apparatus 100 and to employ, as the optimum load, a situation where the load ratio does not rise even when load adjustments are conducted. It is also possible to set 100% of a load ratio as the optimum load and to determine that a parameter that leads to the optimum load has been obtained when the load ratio has become 100%.

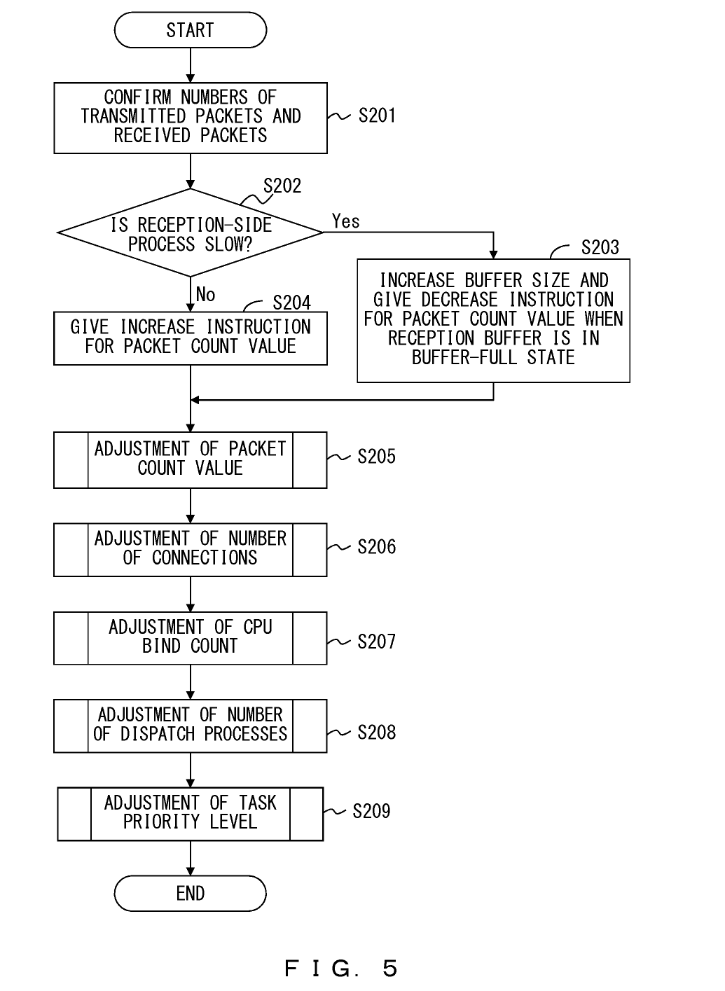

When the control unit 11 has determined in S105, from the load ratio, that the optimum load has not been applied to the network (No in S105), the control unit 11 adjusts parameters sequentially in descending order of influence on an increase/decrease in the load ratio. Also, the control unit 11 changes the setting of resources in the information processing apparatus 100 that are assigned to each port pair (S106). The process in S106 will later be explained by referring to FIG. 5 through FIG. 11.

The control unit 11 determines whether or not the load test has been terminated (S107). When the control unit 11 has determined that the load test has been terminated (Yes in S107), the control unit 11 terminates the adjustment process for the load and changing of the setting of resource assignment. When the control unit 11 has determined that the load test will be continued (No in S107), the control unit 11 repeats the processes in S103 through S107.

When the control unit 11 has determined in S105 from the load ratio that the optimum load has been applied to the network (Yes in S105), the control unit 11 performs the process in S107.

The processes in S103 through S107 above are performed independently from each other by using the resources of the information processing apparatus 100 that have been assigned to each port pair.

As described above, the information processing apparatus 100 dynamically adjusts the parameters while monitoring the load ratio, making it possible to conduct a load test under the optimum load. The information processing apparatus 100 adjusts loads while automatically changing the parameters, making it possible to set the optimum load more efficiently than in a case where several thousands to several tens of thousands of parameters are set manually.

Hereinbelow, explanations will be given for an example of the present invention by referring to FIG. 5 through FIG. 11.

FIG. 5 is a flowchart illustrating the content of an adjustment process for a buffer size.

When the load is not optimum in S105 illustrated in FIG. 4, load adjustment and setting change are conducted in S106.

Then, in FIG. 5, the monitoring unit 12 measures the number of packets that have undergone a transmission process on the transmission side (referred to as transmission-processed packets hereinafter) and the number of packets that have undergone a reception process on the reception side (referred to as reception-processed packets) (S201). A transmission process used herein refers to a process in which a packet is generated on the transmission side and the packet is transmitted to a port on the reception side via a port on the transmission side. A reception process used herein refers to a process in which a transmitted packet is received via a port on the reception side, the packet is stored in the reception buffer and the packet stored in the reception buffer is taken out from the reception buffer in a process on the reception side.

The control unit 11 obtains the numbers of transmission-processed packets and reception-processed packets that were measured by the monitoring unit 12, and confirms whether or not the numbers of the transmission-processed packets and the reception-processed packets differ from each other so as to determine whether or not the process on the reception side is slow (S202).

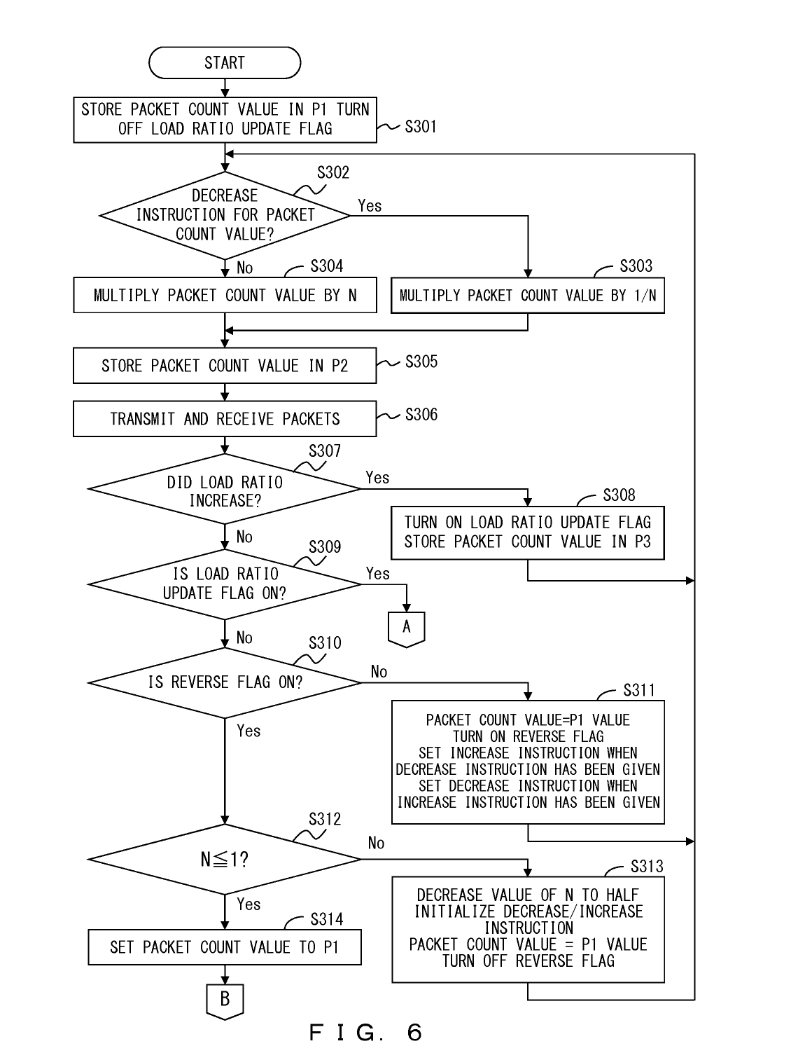

When the number of reception-processed packets is smaller than the number of transmission-processed packets, the control unit 11 determines that the process on the reception side is slow (Yes in S202). Then, the control unit 11 checks the number of packets that have been stored in the reception buffer, and when the storage area for the reception buffer is full of packets (referred to as a buffer-full state hereinafter), the control unit 11 increases the buffer size and gives a decrease instruction for the packet count value (S203). “A decrease instruction for packet count value” is a flag representing an instruction specifying that adjustment to decrease the packet count value is to be conducted. Then, the control unit 11 executes the processes in S205 through S209. The processes in S205 through S209 will be described later by referring to FIG. 6 through FIG. 11.

In the determination of whether or not the number of transmission-processed packets and the number of reception-processed packets are different, the control unit 11 may also use a tolerated difference value, stored in the data table illustrated in FIG. 2C, between the numbers of transmitted packets and received packets so as to determine that they are different when expression (4) below is satisfied. A tolerated difference value between the numbers of transmitted packets and received packets is a value that represents how much difference can be tolerated between the numbers of transmission-processed packets and reception-processed packets.

number of transmission-processed packets−number of reception-processed packets>tolerated difference value between numbers of transmitted packets and received packets (4)

A tolerated difference value between the numbers of transmitted packets and received packets may be set by, for example, predicting an intermission of transmission of packets from the transmission side and setting the tolerated difference value within the range of the numbers of reception-processed packets that can undergo the reception process on the reception side during that intermission.

Also, the size of the reception buffer is increased in the buffer-full state in S203, and the maximum value up to which the size of the reception buffer can be increased is the memory size on the reception side. In other words, when the size of the reception buffer is equal to the memory size on the reception side, it is not possible to increase the size of the reception buffer even in the buffer-full state in S203, and accordingly, only a process of giving a decrease instruction for the packet count value is executed.

When it is determined in S202 that the process on the reception side is not slow, the control unit 11 gives an increase instruction for the packet count value (S204). An increase instruction for the packet count value is a flag representing an instruction that adjustment to increase the packet count value is to be conducted. The control unit 11 executes the processes in S205 through S209 for the packet count adjustment. Also, as illustrated in FIG. 5, regarding S205 through S209, each time a step is terminated by setting the adjusted value of the parameter in that step, the process proceeds to the subsequent step. Also, even when the process of one of steps S201 through S209 that is being executed currently is terminated, the process in S106 illustrated in FIG. 4, i.e., the processing comprising the processes in S201 through S209, is executed repeatedly until it is determined by the control unit 11 that the load test has been terminated in S107 illustrated in FIG. 4. Regarding the determination of the termination of a load test by the control unit 11, it is also possible to determine that a load test has been terminated when an instruction specifying the termination of the load test is input via the input/output interface or when the optimum load is obtained.

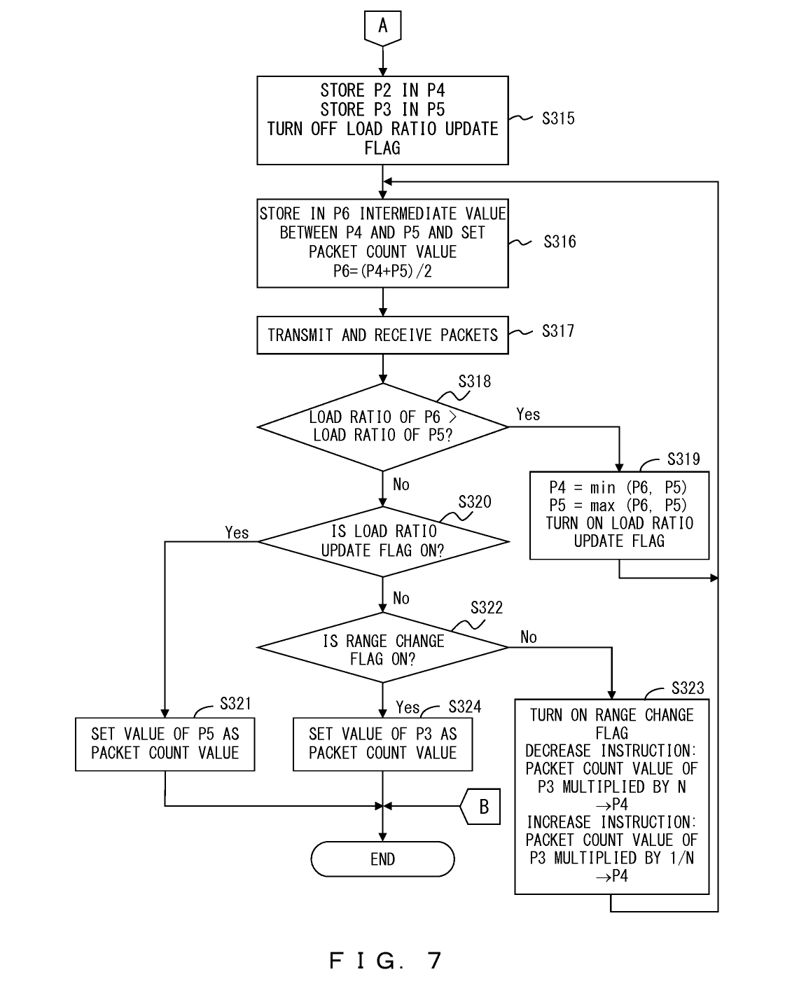

FIG. 6 and FIG. 7 illustrate a flowchart of the content of an adjustment process for a packet count value.

FIG. 6 and FIG. 7 illustrate a flowchart of the content of an adjustment process for a packet count value, which is executed in S205 illustrated in FIG. 5.

The control unit 11 stores the current packet count value in P1, which is a storage area for a packet count value in the data table 23. Then, the control unit 11 turns off the load ratio update flag stored in the data table 23 (S301).

The control unit 11 stores in P1 the packet count value of the initial value table 22 in the first adjustment process for the packet count value after the start of a load test. In the second and subsequent adjustment processes of packet count values, the packet count value that was adjusted in the previous adjustment process may be stored in P1. Also, it is assumed in the following explanations that “P1 through P6” refer to storage areas P1 through P6 for packet count values, respectively.

Then, the control unit 11 determines whether or not a decrease instruction has been given for the packet count value (S302).

When a decrease instruction for the packet count value has been given, the control unit 11 substitutes, into expression (5) below, packet-count-value adjustment variable N stored in the data table 23, and calculates a new packet count value (S303). In other words, a value by which the control unit 11 increases/decreases the packet count value is determined by the specification of packet-count-value adjustment variable N. The packet count value stored in storage area P1 or P3 is substituted for the packet count value. When an adjustment process for the packet count value has been started, the control unit 11 substitutes the packet count value stored in P1 into expression (5).

packet count value×1/N=new packet count value (5)

As packet-count-value adjustment variable N, a value that has been selected from among values greater than one is set in the first adjustment process for a packet count value after the start of a load test. In the second and subsequent adjustment processes of a packet count value, N that was adjusted in the previous adjustment process is set in the data table 23. Also, N may be set to an even value because a packet count value is adjusted by dividing the value by two until N becomes one.

Then, the control unit 11 stores the new packet count value calculated in S303 in P2, which is a storage area specified in the data table 23.

When a decrease instruction has not been given for the packet count value in S302 (when an increase instruction has been given for the packet count value), the control unit 11 substitutes packet-count-value adjustment variable N into expression (6) below so as to calculate a new packet count value (S304). The packet count value stored in storage area P1 or P3 is substituted for the packet count value. When an adjustment process for the packet count value has been started, the control unit 11 substitutes the packet count value stored in P1 into expression (6).

packet count value×N=new packet count value (6)

Then, the control unit 11 stores the new packet count value calculated in S304 in P2, which is a storage area specified in the data table 23 (S305).

The control unit 11 outputs to the testing unit 13 the new packet count value stored in P2. Then, the testing unit 13 outputs generated packets to the port on the transmission side and transmits the packets to the port on the reception side via the transmission-side port each time as many packets as specified by the packet count value input from the control unit 11 have been generated. Thereby, the control unit 11 transmits packets to the port on the reception side via the port on the transmission side, and causes packets to be transmitted and received between the port pair (S306).

When the transmission and reception of packets have been started in S306, the monitoring unit 12 measures the numbers of transmitted packets and received packets so as to obtain a transfer rate, which is the number of packets flowing through a LAN cable per unit time. Then, the monitoring unit 12 calculates the load ratio by dividing the transfer rate by a band that the port pair has. The control unit 11 obtains the load ratio calculated by the monitoring unit 12 and determines whether or not the change in the packet count value increased the load ratio (S307).

When it has been determined that the change in the packet count value increased the load ratio (Yes in S307), the control unit 11 turns on the load ratio update flag stored in the data table 23 and stores in P3 the packet count value at that moment (S308). The packet count value stored in P3 in this process is the packet count value that leads to the maximum load ratio at that moment among those measured in the packet count adjustment process.

Then, the control unit 11 executes the process in S302. When the process has proceeded to S303, the control unit 11 substitutes the packet count value stored in P3 for the packet count value in expression (5). When the process has proceeded to S304, the control unit 11 substitutes the packet count value stored in P3 for the packet count value in expression (6).

The load ratio update flag is a flag indicating that the load ratio has already been updated at least once in the current adjustment process for the packet count value. The same flag as a load ratio update flag used for processes of other parameters may be used as the load ratio update flag, and it is also possible to store, in a different storage area in a storage device 205 for each parameter, a flag that is used independently.

When it has been determined that the change in the packet count value did not increase the load ratio, the control unit 11 refers to the load ratio update flag stored in the data table 23 (S309).

The control unit 11 makes the process proceed to S315 when the load ratio update flag is on (Yes in S309).

When the load ratio update flag is off (No in S309), the control unit 11 refers to a reverse flag, which is a flag, stored in the data table 23, indicating whether or not an increase/decrease in the packet count value in the reverse direction has already been specified in the current adjustment process for the packet count value (S310).

When the reverse flag is off, the control unit 11 changes the instruction for the packet count value to an increase instruction when the instruction has been a decrease instruction and changes the instruction to a decrease instruction when the instruction has been an increase instruction because the change in the packet count value did not increase the load ratio. Further, the control unit 11 resets the packet count value to the packet count value stored in P1, and turns on the reverse flag (S311). Then, the control unit 11 executes the process in S302. Thereafter, after the process has proceeded to S303, the control unit 11 substitutes the packet count value stored in P1 for the packet count value in expression (5). When the process has proceeded to S304, the control unit 11 substitutes the packet count value stored in P1 for the packet count value in expression (6).

When the reverse flag is off in S310, the control unit 11 checks whether or not it is possible to decrease the value of packet-count-value adjustment variable N (S312). Specifically, because the packet count value is to decrease when packet-count-value adjustment variable N is substituted into expression (5) and the packet count value is to increase when packet-count-value adjustment variable N is substituted into expression (6), N is a value equal to or greater than one. Accordingly, it is determined that it is not possible to decrease packet-count-value adjustment variable N when N≦1 is satisfied.

When the condition N≦1 is not satisfied in S312, the control unit 11 decreases the value of packet-count-value adjustment variable N to half (N×1/2). Also, the control unit 11 resets the increase instruction for the packet count value and the decrease instruction for the packet count value to the values set at the start of the adjustment of the packet count value in S205. Further, the control unit 11 resets the packet count value to the value stored in P1. Also, the control unit 11 turns off the reverse flag (S313). Then, the control unit 11 executes the process in S302. Thereafter, when the process has proceeded to S303, the control unit 11 substitutes the packet count value stored in P1 for the packet count value in expression (5). Also, when the process has proceeded to S304, the control unit 11 substitutes the packet count value stored in P1 for the packet count value in expression (6).

In decreasing the value of packet-count-value adjustment variable N to half in S313, the control unit 11 sets N=1 when N<1. Thereby, when packet-count-value adjustment variable N is substituted into expressions (5) and (6), the increase instruction and the decrease instruction for the packet count value are not different from the actual instructions. It is also possible to satisfy the condition N=1 before the condition N<1 is satisfied, by setting packet-count-value adjustment variable N to an even number in advance.

When N≦1 in S312, which means that the an increase/decrease in the packet count value has not increased the load ratio, the control unit 11 sets the packet count value to the value stored in P1 and terminates the adjustment process for the packet count value (S314).

When the load ratio update flag has been determined to be on in S309 in FIG. 6, the control unit 11 executes the process in S315 illustrated in FIG. 7.

The control unit 11 refers to the data table 23 and stores, in storage area P4, the packet count value stored in storage area P2, which is the packet count value set at the first transmission/reception of a packet (S315). Further, the control unit 11 stores, in storage area P5, the packet count value stored in storage area P3 for which the load ratio was the maximum. Also, the control unit 11 turns off the load ratio update flag.

In the process in S315 through 5323, a packet count value that leads to a high load is obtained between the packet count value stored in P4 and the packet count value stored in P5. In other words, fine adjustment of the adjustment process for the packet count value executed in S302 through S314 is conducted.

The control unit 11 substitutes the two packet count values stored in P4 and P5 into expression (7) below so as to calculate the intermediate value between the two packet count values stored in P4 and P5, and stores the value as a new packet count value in P6.

P6=(P4+P5)/2: decimals are rounded to the nearest whole number (7)

Note that in expression (7), P4 is a packet count value stored in P4, P5 is a packet count value stored in P5 and P6 is a new packet count value stored in P6.

Then, the control unit 11 outputs to the testing unit 13 the new packet count value stored in P6 and thereby transmits a packet to a port on the reception side via a port on the transmission side similarly to S306, and causes packets to be transmitted and received between the port pair (S317).

When the transmission and reception of packets have been started in S317, the monitoring unit 12 measures the numbers of packets that are being transmitted and received, and obtains the transfer rate, which is the number of packets flowing through a LAN cable per unit time. The monitoring unit 12 calculates the load ratio by dividing the transfer rate by a band that the port pair has. The control unit 11 obtains the load ratio calculated by the monitoring unit 12 and determines whether or not the change in the packet count value increased the load ratio (Yes in S318). Specifically, the control unit 11 determines whether or not the load ratio obtained when the packet count value stored in P5 (referred to as the load ratio of P5 hereinafter) is set is greater than the load ratio obtained when the packet count value stored in P6 (referred to as the load ratio of P6) is set. Note that the load ratio of P5 is the load ratio stored in P3 in S308 when S318 is executed first in the current adjustment process for the packet count value.

When the load ratio of P6 is greater than load ratio of P5 (Yes in S318), the control unit 11 stores in P4 the packet count value of the lower load ratio between the packet count values of P6 and P5. Also, the control unit 11 stores in P5 the packet count value of the higher load ratio between the packet count values of P6 and P5. Further, the control unit 11 turns on the load ratio update flag (S319). Then, the control unit 11 executes the process in S316.

When the load ratio of P6 is equal to or lower than the load ratio of P5, the control unit 11 checks whether or not the load ratio update flag stored in the data table 23 is on (S320).

When the load ratio update flag is on (Yes in S320), the intermediate value between the packet count values of P5 and P6 is set so as to indicate that a process of increasing the load ratio has been executed. In this process, the control unit 11 sets the packet count value, stored in P5, that led to the highest load without executing further processes, as the adjusted value of the packet count value (S321). Then, the control unit 11 terminates the adjustment process for the packet count value.

Note that an adjusted value of a packet count value is a packet count value (parameter) that led to the highest load ratio (the closest to the determined load ratio) and is the packet count value set for a load test.

When the load ratio update flag is off, because the load ratio has not increased even when the intermediate value of the packet count values of P5 and P6 was set, the control unit 11 determines whether or not to further adjust the packet count value by changing the ranges of P5 and P6 (S322). Specifically, the control unit 11 refers to a range change flag, which is a flag that is initially set to off and is turned on when the range is changed in the current adjustment process for the packet count value. In other words, when the range change flag is on, this indicates that the load ratio has not increased even when the processes in S316 through 320 were executed after an increase in the load ratio caused by a change in the range in S322, which will be explained later. Also, the range change flag is reset to off each time an adjustment process for a packet count value is terminated.

When the range change flag is off (No in S322), the control unit 11 turns on the range change flag. Then, the control unit 11 calculates the packet count value that is a result of multiplying the packet count value stored in P3 by N when a decrease instruction for the packet count value has been given. Also, when the range change flag is off (No in S322), the control unit 11 calculates the packet count value that is a result of multiplying the packet count value of P3 by 1/N (with decimals rounded to the nearest whole number). Then, the control unit 11 stores the calculated packet count value in storage area P4 (S323). Thereafter, the control unit 11 executes the process in S316.

When the range change flag is on (Yes in S322), the control unit 11 determines that a change in the ranges of P5 and P6 will not increase the load ratio, and sets the packet count value of P3 as the adjusted packet count value (S324). Then, the control unit 11 terminates the adjustment process for the packet count value.

As described above, the control unit 11 increases/decreases the packet count value so as to set, as the adjusted value of the packet count value, the packet count value that leads to the maximum load ratio. Thereby, the information processing apparatus 100 can adjust the packet count value over a range from a rough level to a fine level so as to set a packet count value that leads to the optimum load ratio. In the explanations above, an example in which the packet count value that leads to the maximum load ratio is found has been used, but it is also possible to set a load ratio determined as a desirable load ratio and adjust the packet count value so that the load ratio becomes closer to the set load ratio.

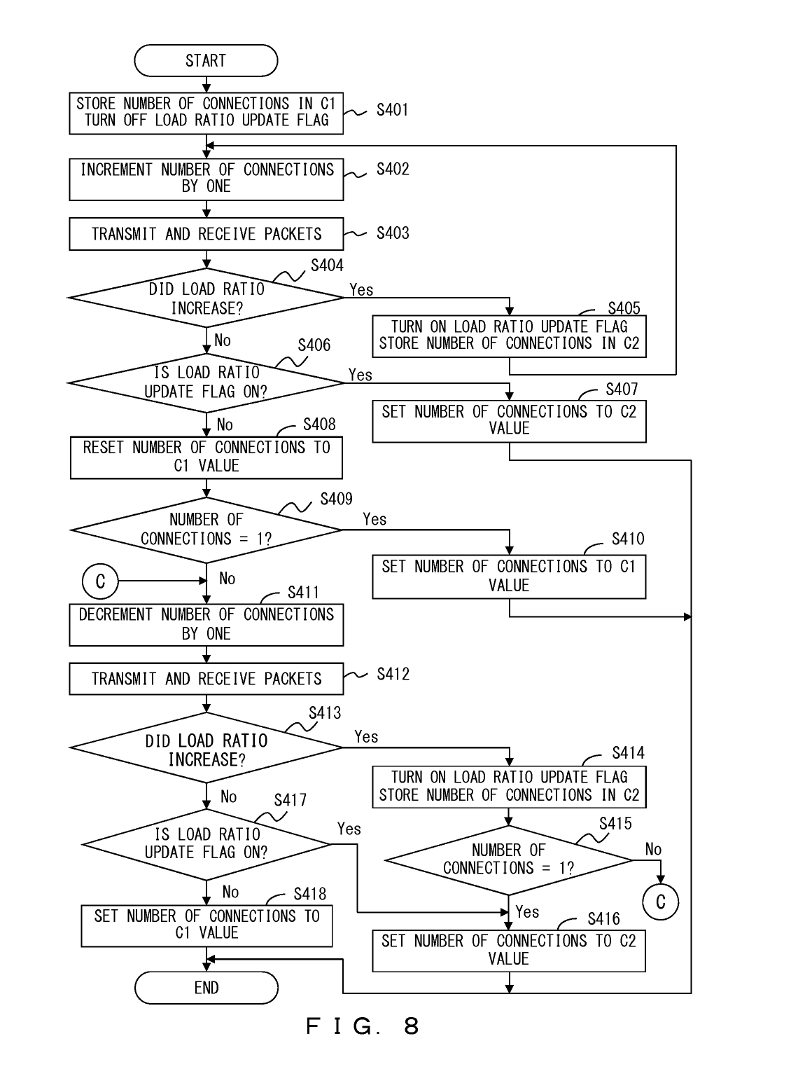

FIG. 8 illustrates a flowchart illustrating the content of an adjustment process for a number of connections.

FIG. 8 illustrates a flowchart illustrating the content of an adjustment process for a number of connections in S206 illustrated in FIG. 5.

The control unit 11 stores the current number of connections in C1, which is a storage area specified in the data table 23. Also, in the first adjustment process for the number of connections after the start of a load test, the control unit 11 stores, in C1, the number of connections in the initial value table 22. In the second and subsequent adjustment processes of the number of connections, it is also possible to store the number of connections that was adjusted previously. In the explanations below, “C1” and “C2” respectively refer to storage areas C1 and C2 for the numbers of connections.

Then, the control unit 11 turns off the load ratio update flag stored in the data table 23 (S401).

Next, the control unit 11 sets, as a new number of connections, a value obtained by incrementing by one the number of connections stored in C1 (S402).

The control unit 11 outputs to the testing unit 13 the new number of connections set in S402. Then, the testing unit 13 generates as many communication channels for a logical packet between the transmission-side port and the reception-side port as specified by the number of connections input from the control unit 11, and transmits packets to the reception-side port via the transmission-side port (S403). Thereby, the control unit 11 transmits packets to the reception-side port via the transmission-side port so that packets are transmitted and received between the port pair.

When the transmission and reception of packets have been started in S403, the monitoring unit 12 measures the numbers of transmitted packets and received packets so as to obtain a transfer rate, which is the number of packets flowing through a LAN cable per unit time. Then, the monitoring unit 12 calculates the load ratio by dividing the transfer rate by a band that the port pair has. The control unit 11 obtains the load ratio calculated by the monitoring unit 12 and determines whether or not the change in the number of connections increased the load ratio (S404).

When it has been determined that the increase in the number of connections increased the load ratio (Yes in S404), the control unit 11 turns on the load ratio update flag stored in the data table 23, and stores a new number of connections in C2 (S405). Note that the number of connections stored in C2 in this process is a number of connections that leads to the maximum load ratio among those that were measured in the adjustment process for the numbers of connections at that moment. Then, the control unit 11 executes the process in S402.

The load ratio update flag is a flag indicating that the load ratio has already been updated at least once in the current adjustment process for the number of connections. The same flag as a load ratio update flag used for processes of other parameters may be used as the load ratio update flag, and it is also possible to store, in a different storage area in the storage device 205 for each parameter, a flag that is used independently.

When it has been determined that the change in the number of connections did not increase the load ratio, the control unit 11 refers to the load ratio update flag stored in the data table 23 (S406).

When the load ratio update flag is on (Yes in S406), the control unit 11 determines that the maximum load ratio has been obtained by increasing the number of connections. In other words, the control unit 11 determines that a decrease in the number of connections will not increase the load ratio. Then, the control unit 11 sets the adjusted value of the number of connections to the value stored in C2 (S407) and terminates the adjustment process for the number of connections.

Note that an adjusted value of a number of connections (parameter) is a number of connections that led to the highest load ratio (the closest to the determined load ratio) and is the number of connections set for a load test.

When the load ratio update flag is off (No in S406), the control unit 11 executes a process of determining whether or not the load ratio increases after decreasing the number of connections stored in C1 because the load ratio did not increase even after the increase in the number of connections. Accordingly, the control unit 11 resets the number of connections to the value stored in C1 (S408).

In the process below, it is determined whether or not a decrease in the number of connections increases the load ratio.

The control unit 11 determines whether or not the number of connections is one (S409). When the number of connections is one (Yes in S409), which means that the number of connections will not decrease further, the number of connections is set to the value stored in C1, in other words, the number of connections is set to one (S410). Then, the control unit 11 terminates the adjustment process for the number of connections.

When the number of connections is not one, which means that the number of connections is a value equal to or greater than two, the control unit 11 sets a value obtained by decrementing the number of connections by one as a new number of connections (S411).

Then, the control unit 11 outputs to the testing unit 13 the new number of connections set in S411 and thereby transmits a packet to a port on the reception side via a port on the transmission side similarly to S403, and causes packets to be transmitted and received between the port pair (S412).

When the transmission and reception of packets have been started in S412, the monitoring unit 12 measures the numbers of transmitted packets and received packets so as to obtain a transfer rate, which is the number of packets flowing through a LAN cable per unit time. Then, the monitoring unit 12 calculates the load ratio by dividing the transfer rate by a band that the port pair has. The control unit 11 obtains the load ratio calculated by the monitoring unit 12 and determines whether or not the change in the number of connections increased the load ratio (S413).

When it has been determined that the decrease in the number of connections increased the load ratio (Yes in S413), the control unit 11 turns on the load ratio update flag stored in the data table 23 and stores the new number of connections in storage area C2 (S414).

Then, the control unit 11 determines whether or not the number of connections stored in C2 in S414 is one (S415). When the number of connections stored in C2 in S414 is not one (No in S415), the control unit 11 executes the process in S411 in order to determine whether or not the load ratio will increase when the number of connections is decreased further.

When the number of connections is one (Yes in S415), which means that the number of connections will not decrease further, the number of connections is set to the value stored in C2 as the adjusted value of the number of connections (S416). Then, the control unit 11 terminates the adjustment process for the number of connections.

When it has been determined that the change in the number of connections did not increase the load ratio (No in S413), the control unit 11 determines whether or not the load ratio update flag is on (S417).

When the load ratio update flag is on (Yes in S417), the control unit 11 determines that the load ratio will not increase further even when the number of connections is increased, and executes the process in S416. Then, the control unit 11 terminates the adjustment process for the number of connections.

When the load ratio update flag is off (No in S417), the control unit 11 sets the number of connections stored in C1 as the adjusted value of the number of connections because the load ratio did not increase or decrease even after an increase or decrease in the number of connections (S418). Then, the control unit 11 terminates the adjustment process for the number of connections.

As will be described below, the control unit 11 increases/decreases the number of connections so as to set, as the number of connections, the number of connections that leads to the maximum load ratio. Thereby, the information processing apparatus 100 can set the number of connections that leads to the optimum load ratio. In the explanations above, an example in which the number of connections that leads to the maximum load ratio is found has been used, but it is also possible to set a load ratio that is determined as a desirable load ratio and adjust the number of connections so that the load ratio becomes closer to the determined load ratio.

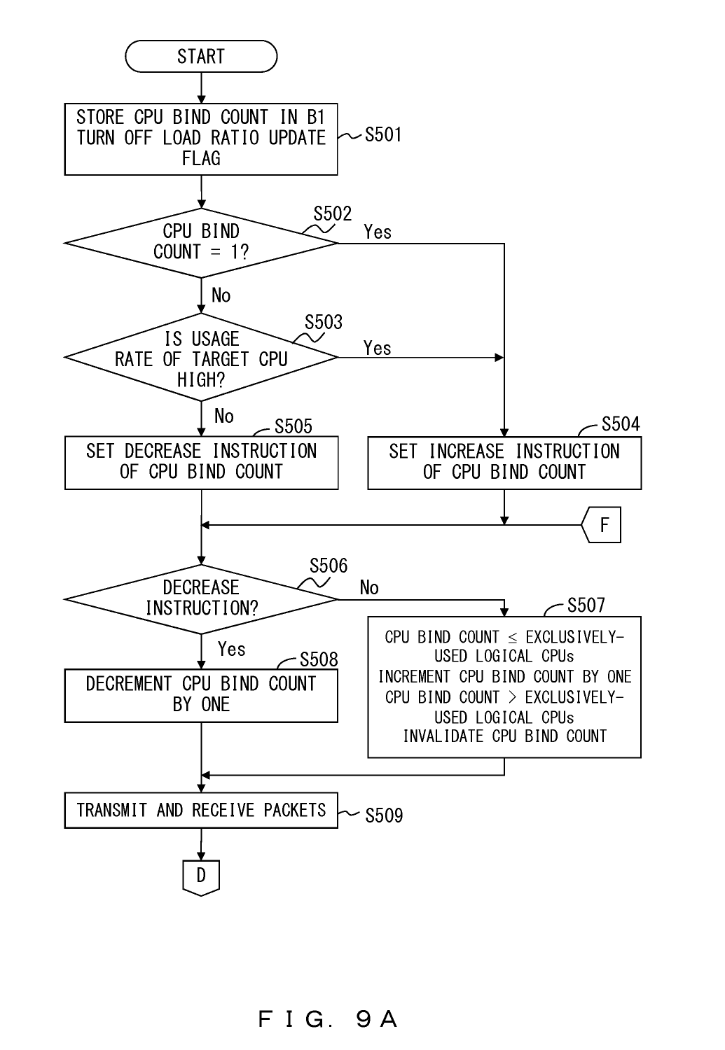

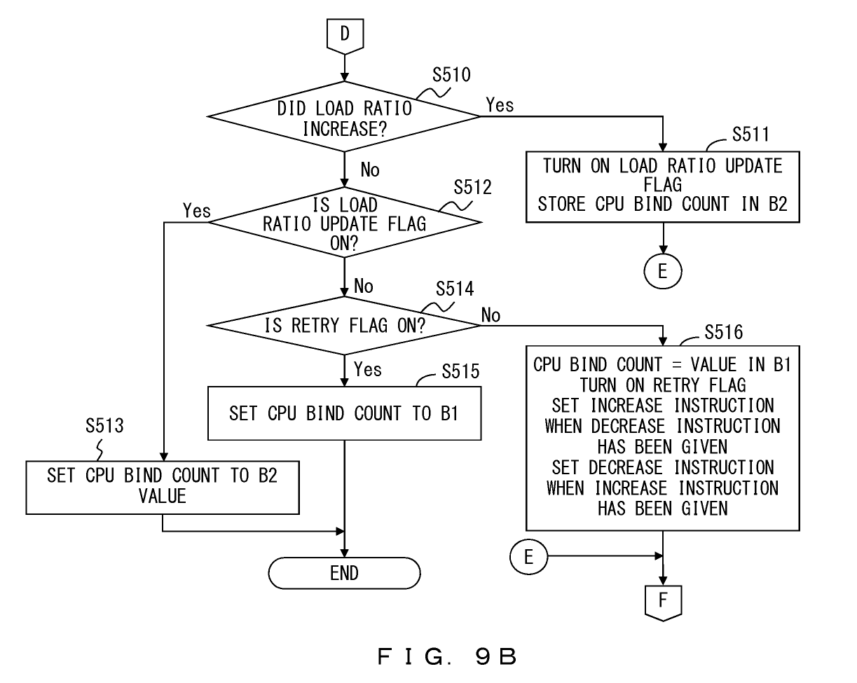

FIG. 9A and FIG. 9B are flowcharts illustrating the content of an adjustment process for a CPU bind count.

FIG. 9A and FIG. 9B are flowcharts illustrating the content of an adjustment process for a CPU bind count in S207 illustrated in FIG. 5.

The control unit 11 stores the current CPU bind count in B1, which is a storage area specified in the data table 23. Also, in the first adjustment process for the CPU bind count after the start of a load test, the control unit 11 stores, in B1, the CPU bind count in the initial value table 22. In the second and subsequent adjustment processes of the CPU bind count, it is also possible to store the CPU bind count that was adjusted previously. In the explanations below, “B1” and “B2” respectively refer to storage areas B1 and B2 for the CPU bind counts.

Then, the control unit 11 turns off the load ratio update flag stored in the data table 23 (S501).

Next, the control unit 11 determines whether or not the CPU bind count is one (S502). When the CPU bind count is not one (No in S502), the control unit 11 determines whether or not the usage rate of the bound CPUs is high (S503). The control unit 11 checks whether or not the CPU usage rate is higher than, for example, 90 percent (a threshold that is specified on an as-needed basis).

When the CPU bind count is one in S502 (Yes in S502) and when it has been determined that the CPU usage rate is high in S503, the control unit 11 gives an increase instruction for the CPU bind count (S504). The purpose of the control unit 11 giving an increase instruction for the CPU bind count is to check whether or not a situation has arisen in which the CPU usage rate is high and there is not sufficient time for assigning CPUs to transmission/reception tasks, so that the execution of the processes of generating and transmitting packets has been delayed and the transfer rate has deteriorated. In other words, the control unit 11 increases the CPU bind count so as to decrease the CPU usage rate and thereby secures sufficient time for assigning CPUs and checks whether or not the network load increases. Thereby, it is possible for the control unit 11 to determine that it is better to set, as an adjusted value, a value resulting from increasing the CPU bind count when the network load increases with the CPU bind count having increased because time for assigning CPUs to transmission/reception tasks is not sufficient. Note that an adjusted value of a CPU bind count is the CPU bind count that leads to the highest load ratio (closest to the determined load ratio) in an adjustment process for the CPU bind count (parameter) and is the CPU bind count set for a load test.

When it has been determined that the CPU usage rate is not high, the control unit 11 gives a decrease instruction for the CPU bind count in order to decrease the CPU bind count (S505). The reason for the control unit 11 giving a decrease instruction for the CPU bind count may be considered to be that the CPU usage rate is low and the assignment of CPUs to transmission/reception tasks has proceeded sufficiently. However, in some cases, the network load ratio is increased by reducing the number of bound CPUs. Accordingly, the purpose of the control unit 11 giving a decrease instruction for the CPU bind count is to adjust the CPU bind count dynamically and check whether or not the network load ratio increases with a decreased CPU bind count. Note that “CPU usage rate is not high” refers to a situation where, for example, the CPU usage rate is 90 percent (a threshold specified on an as-needed basis) or lower.

The control unit 11 checks whether or not a decrease instruction has been given for the CPU bind count (S506).

When an increase instruction has been given for the CPU bind count in S506 (No in S506), the control unit 11 increments by one the CPU bind count when the CPU bind count is equal to or smaller than the number of logical CPUs that can be used exclusively. Also, when an increase instruction has been given for the CPU bind count in S506 and the count has exceeded the number of logical CPUs that can be used exclusively, the control unit 11 invalidates the CPU bind count (S507). Thereby, the control unit 11 sets the value set in S507 as a new CPU bind count. Note that “invalidates the CPU bind count” refers to, for example, making a plurality of port pairs share a CPU included in the information processing apparatus 100. Also, when a CPU bind count has been invalidated, the CPU bind count may be, for example, zero.

When a decrease instruction has been given for the CPU bind count in S506 (Yes in S506), the control unit 11 decrements by one the CPU bind count when the CPU bind count is equal to or smaller than the number of logical CPUs that can be used exclusively, and sets the resultant value as a new CPU bind count (S508). However, when the CPU bind count is one, that CPU bind count remains unchanged.

The control unit 11 outputs to the testing unit 13 the new CPU bind count set in S507 and 5508. Then, the testing unit 13 generates packets by using as many logical CPUs as specified by the CPU bind count input from the control unit 11, and transmits the packets to a port on the reception side from a port on the transmission side (S509). Thereby, the control unit 11 transmits packets to a port on the reception side via a port on the transmission side so that packets are transmitted and received between a port pair. Note that in S509, when a CPU bind count is zero (invalidated CPU bind count), it is also possible to make a plurality of port pairs share a CPU included in the information processing apparatus 100.

When the transmission and reception of packets have been started in S509, the monitoring unit 12 measures the numbers of transmitted packets and received packets so as to obtain a transfer rate, which is the number of packets flowing through a LAN cable per unit time. Then, the monitoring unit 12 calculates the load ratio by dividing the transfer rate by a band that the port pair has. The control unit 11 obtains the load ratio calculated by the monitoring unit 12 and determines whether or not the change in the CPU bind count increased the load ratio (S510).

When it has been determined that the change in the CPU bind count increased the load ratio (Yes in S510), the control unit 11 turns on the load ratio update flag stored in the data table 23 and stores the new CPU bind count in storage area B2 (S511). The CPU bind count stored in B2 in this process is the CPU bind count that leads to the maximum load ratio at that moment among those measured in the adjustment process for the CPU bind count. Then, the control unit 11 executes the process in S506.

The load ratio update flag is a flag indicating that the load ratio has already been updated at least once in the current adjustment process for the CPU bind count. The same flag as a load ratio update flag used for processes of other parameters may be used as the load ratio update flag, and it is also possible to store, in a different storage area in the storage device 205 for each parameter, a flag that is used independently.

When it has been determined that the change in the CPU bind count did not increase the load ratio, the control unit 11 refers to the load ratio update flag stored in the data table 23 (S512).

When the load ratio update flag is on (Yes in S512), the control unit 11 determines that the load ratio will not increase further even when the CPU bind count is adjusted, and sets the adjusted value of the CPU bind count to the value stored in B2 (S513). Then, the control unit 11 terminates the adjustment process for the CPU bind count.

When the load ratio update flag is off in S512 (No in S512), the control unit 11 determines whether or not the retry flag stored in the data table 23 is on (S514). A retry flag is a flag representing whether or not the CPU bind count has already been increased or decreased in the current adjustment process for the CPU bind count, and indicates, by being on, that the load ratio has not increased despite the fact that the CPU bind count has already been increased or decreased.

When the retry flag is on in S514 (Yes in S514), the control unit 11 changes the adjusted value of the CPU bind count to the value stored in B1 (S515).

When the retry flag is off in S514 (No in S514), the control unit 11 turns on the retry flag and resets the CPU bind count to the CPU bind count stored in B1. Further, when the current instruction for the CPU bind count is an increase instruction, the control unit 11 gives a decrease instruction, and when the current instruction for the CPU bind count is a decrease instruction, the control unit 11 gives an increase instruction for the CPU bind count (S516). Then, the control unit 11 executes the process in S506.

As described above, the control unit 11 increases/decreases the CPU bind count so as to set, as the adjusted CPU bind count, the CPU bind count that leads to the maximum load ratio. Thereby, the information processing apparatus 100 can set the CPU bind count that leads to the optimum load. In the explanations above, an example in which the CPU bind count that leads to the maximum load ratio is found has been used, but it is also possible to set a load ratio determined as a desirable load ratio and adjust the CPU bind count so that the load ratio becomes closer to the set load ratio.

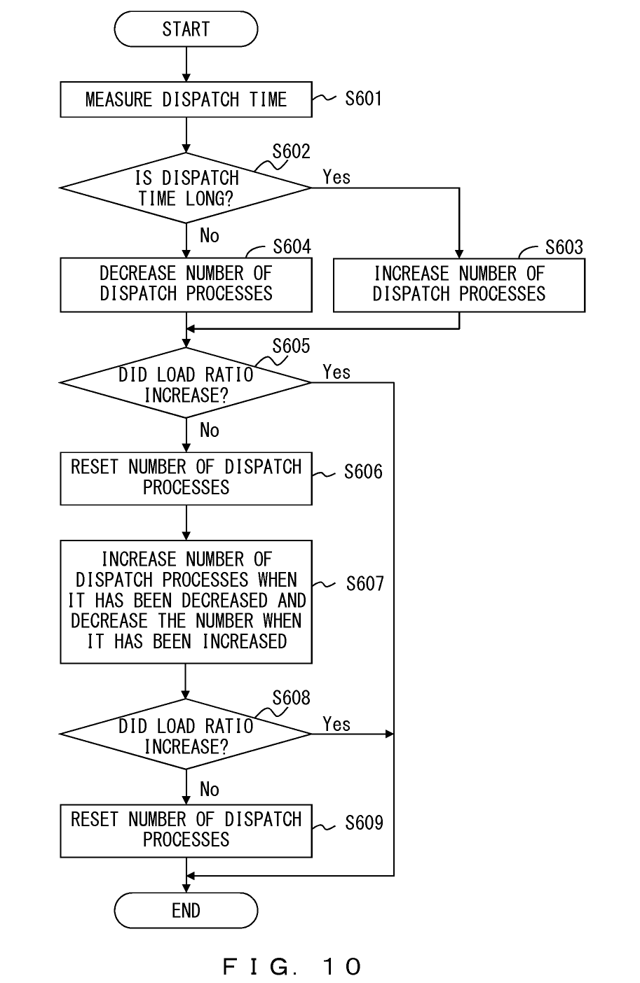

FIG. 10 is a flowchart illustrating the content of an adjustment process for a number of dispatch processes.

FIG. 10 is a flowchart illustrating the content of an adjustment process for a number of dispatch processes in S208 illustrated in FIG. 5.

The control unit 11 measures a period of time between when the control unit 11 dispatches a transmission/reception task for transmitting/receiving packets between a port pair and when the assignment of a CPU to the transmission/reception task is returned after the assignment of a CPU to the transmission/reception task is cancelled (referred to as a dispatch time hereinafter) (S601).

Then, the control unit 11 refers to a reference value of the dispatch time stored in the data table 23, and compares the reference value with the dispatch time measured in S601 (S602).

When the dispatch time is longer than the dispatch-time reference value in S602, the control unit 11 determines that the dispatch time is long and increases the number of dispatch processes so as to set a new number of dispatch processes (S603). “Increases the number of dispatch processes” used herein refers to increasing the number of processes of transmission/reception tasks executed for one time of assignment of a logical CPU for executing a transmission/reception task. Thereby, a transmission/reception task exclusively uses, for a longer period of time, a logical CPU assigned to a port pair. Note that it is also possible to employ a configuration in which a number of dispatch processes that is determined on an as-needed basis is stored in the storage device 305 and the control unit 11 refers to the storage device 305 in S603 to use it.

When the dispatch time is shorter than the dispatch-time reference value in S602, the control unit 11 determines that the dispatch time is short and decreases the number of dispatch processes so as to set a new number of dispatch processes (S604). “Decreases the number of dispatch processes” used herein refers to decreasing the number of processes of transmission/reception tasks executed for one time of assignment of a logical CPU for executing a transmission/reception tasks. Thereby, a transmission/reception task exclusively uses, for a shorter period of time, a logical CPU assigned to a port pair. Note that it is also possible to employ a configuration in which a smaller number of transmission/reception tasks than there are logical CPUs assigned to a port pair is stored in the storage device 305 and the control unit 11 refers to the storage device 305 in S603 to use it.

The control unit 11 outputs to the testing unit 13 the new number of dispatch processes set in S603 and S604. Then, the testing unit 13 executes the task each time a logical CPU is assigned and the testing unit 13 transmits packets to a port on the reception side from a port on the transmission side until the number of times of execution reaches the number of dispatch processes input from the control unit 11. Thereby, the control unit 11 transmits packets to the reception-side port via the transmission-side port so that packets are transmitted and received between the port pair.

When the transmission and reception of packets have been started, the monitoring unit 12 measures the numbers of transmitted packets and received packets so as to obtain a transfer rate, which is the number of packets flowing through a LAN cable per unit time. Then, the monitoring unit 12 calculates the load ratio by dividing the transfer rate by a band that the port pair has. The control unit 11 obtains the load ratio calculated by the monitoring unit 12 and determines whether or not the change in the number of dispatch processes increased the load ratio (S605).

When the control unit 11 has determined that the change in the number of dispatch processes increased the load ratio (Yes in S605), the control unit 11 sets the number of dispatch processes that was newly set, as an adjusted value of the number of dispatch processes. Also, the control unit 11 stores the adjusted value of the number of dispatch processes in storage area D1 for the number of dispatch processes. Then, the control unit 11 terminates the adjustment process for the number of dispatch processes.

When it has been determined that the change in the number of dispatch processes did not increase the load ratio (No in S605), the control unit 11 resets the number of dispatch processes (S606).

Then, the control unit 11 readjusts the number of dispatch processes. The control unit 11 increases the number of dispatch processes so as to set a new number of dispatch processes when the number of dispatch processes has been decreased in the current adjustment process for the number of dispatch processes. When the number of dispatch processes has been increased in the current adjustment process for the number of dispatch processes, the control unit 11 decreases the number of dispatch processes so as to set a new number of dispatch processes (S607).

Similarly to the process in S605, the control unit 11 determines whether or not an increase/decrease in the number of dispatch processes increased the load ratio (S608).

When it has been determined that the change in the number of dispatch processes increased the load ratio (Yes in S608), the control unit 11 sets the newly set number of dispatch processes as the adjusted value of the number of dispatch processes.

When it has been determined that the change in the number of dispatch processes did not increase the load ratio (No in S608), the control unit 11 resets the number of dispatch processes, and sets the initial number of dispatch processes as the adjusted value of the number of dispatch processes (S609). Also, the control unit 11 stores the adjusted value of the number of dispatch processes in storage area D1 for the number of dispatch processes. Also, the control unit 11 terminates the adjustment process for the number of dispatch processes.

In the above explanations, the initial number of dispatch processes maybe stored in the initial value table 22. In such a case, the control unit 11 extracts the number of dispatch processes from the initial value table in S601 so as to dispatch a transmission/reception task.

Also, in the above explanations, the processes in S603 through S605 and S607 and S608 may be repeated as long as the load ratio is on the increase.

As described above, the control unit 11 increases/decreases the number of dispatch processes so as to set, as the adjusted number of dispatch processes, the number of dispatch processes that leads to the maximum load ratio. This makes it possible for the information processing apparatus 100 to set the number of dispatch processes that leads to the optimum load. In the explanations above, an example in which the number of dispatch processes that leads to the maximum load ratio is found has been used, but it is also possible to set a load ratio determined as a desirable load ratio and adjust the number of dispatch processes so that the load ratio becomes closer to the set load ratio.

FIG. 10 is a flowchart illustrating the content of an adjustment process for a number of dispatch processes.

FIG. 10 is a flowchart illustrating the content of an adjustment process for a number of dispatch processes in S208 illustrated in FIG. 5. In the following explanations, a case will be described in which one transmission/reception task is being executed, for simplicity of the explanation.

The control unit 11 measures a period of time between when the control unit 11 dispatches a transmission/reception task and when the assignment of a CPU is returned (referred to as a dispatch time hereinafter) (S601).

Then, the control unit 11 refers to a reference value of the dispatch time stored in the data table 23, and compares the reference value with the dispatch time measured in S601 (S602).

When the dispatch time is longer than the dispatch-time reference value (Yes in S602), the control unit 11 determines that the dispatch time is long and increases the number of dispatch processes so as to set a new number of dispatch processes (S603).

“Increases the number of dispatch processes” used herein refers to increasing the number of processes of transmission/reception tasks executed for one time of assignment of a logical CPU for executing a transmission/reception task. Thereby, a transmission/reception task exclusively uses, for a longer period of time, a logical CPU assigned to a port pair. Note that it is also possible to employ a configuration in which a number of dispatch processes that is determined on an as-needed basis is stored in the storage device 305 and the control unit 11 refers to the storage device 305 in S603 to use it.

When the dispatch time is shorter than the dispatch-time reference value (No in S602), the control unit 11 determines that the dispatch time is short and decreases the number of dispatch processes so as to set a new number of dispatch processes (S604). “Decreases the number of dispatch processes” used herein refers to decreasing the number of processes of transmission/reception tasks executed for one time of assignment of a logical CPU for executing a transmission/reception task. Thereby, a transmission/reception task exclusively uses, for a shorter period of time, a logical CPU assigned to a port pair. Note that it is also possible to employ a configuration in which a number of dispatch processes that is determined on an as-needed basis is stored in the storage device 305 and the control unit 11 refers to the storage device 305 in S603 to use it.

The control unit 11 outputs to the testing unit 13 the new number of dispatch processes set in S603 and S604. Then, the testing unit 13 executes the task each time a logical CPU is assigned, and transmits packets to a port on the reception side from a port on the transmission side until the number of times of execution reaches the number of dispatch processes input from the control unit 11. Thereby, the control unit 11 transmits packets to the reception-side port via the transmission-side port so that packets are transmitted and received between the port pair.

When the transmission and reception of packets have been started, the monitoring unit 12 measures the numbers of transmitted packets and received packets so as to obtain a transfer rate, which is the number of packets flowing through a LAN cable per unit time. Then, the monitoring unit 12 calculates the load ratio by dividing the transfer rate by a band that the port pair has. The control unit 11 then obtains the load ratio calculated by the monitoring unit 12 and determines whether or not the change in the number of dispatch processes increased the load ratio (S605).

When it has been determined that the change in the number of dispatch processes increased the load ratio (Yes in S605), the control unit 11 stores the number of dispatch processes that was newly set, in storage area D1 for the number of dispatch processes in the data table 23. Then, the control unit 11 sets the newly set number of dispatch processes as the adjusted value of the number of dispatch processes.

When it has been determined that the change in the number of dispatch processes did not increase the load ratio (No in S605), the control unit 11 resets the number of dispatch processes to the initial value (S606). The initial value of the number of dispatch processes is the number of dispatch processes set when the process in S601 is executed.

Then, the control unit 11 readjusts the number of dispatch processes. The control unit 11 increases the number of dispatch processes so as to set a new number of dispatch processes when the number of dispatch processes has been decreased in the current adjustment process for the number of dispatch processes. When the number of dispatch processes has been increased in the current adjustment process for the number of dispatch processes, the control unit 11 decreases the number of dispatch processes so as to set a new number of dispatch processes (S607).

Similarly to the process in S605, the control unit 11 determines whether or not an increase/decrease in the number of dispatch processes increased the load ratio (S608).

When it has been determined that the change in the number of dispatch processes increased the load ratio (Yes in S608), the control unit 11 stores the number of dispatch processes that was newly set, in storage area D1 for the number of dispatch processes in the data table 23. Then, the control unit 11 sets the newly set number of dispatch processes as the adjusted value of the number of dispatch processes.

When it has been determined that the change in the number of dispatch processes did not increase the load ratio (No in S608), the control unit 11 resets the number of dispatch processes to the initial value, and stores the initial number of dispatch processes in storage area D1 for the number of dispatch processes in the data table 23. Then, the control unit 11 sets the initial number of dispatch processes as the adjusted value of the number of dispatch processes (S609).

In the above explanations, the initial number of dispatch processes maybe stored in the initial value table 22. In such a case, the control unit 11 extracts the number of dispatch processes from the initial value table in S601 so as to dispatch a transmission/reception task.

Also, in the above explanations, the processes in S603 through S605 and S607 and S608 may be repeated as long as the load ratio is on the increase.

In the increase/decrease process for the number of dispatch processes in S603, S604 and S607, when there are a plurality of numbers of connections, the numbers of dispatch processes of all transmission/reception tasks may be increased/decreased simultaneously. Also, when there are a plurality of numbers of connections, the adjustment processes for the numbers of dispatch processes in S601 through S609 illustrated in FIG. 10 may be executed in a one-by-one manner for each transmission/reception task.

As described above, the control unit 11 increases/decreases the number of dispatch processes so as to set the number of dispatch processes that leads to the maximum load ratio, as the adjusted number of dispatch processes. Thereby, the information processing apparatus 100 can set the number of dispatch processes that leads to the optimum load ratio. In the explanations above, an example in which the number of dispatch processes that leads to the maximum load ratio is found has been used, but it is also possible to set a load ratio determined as a desirable load ratio and adjust the number of dispatch processes so that the load ratio becomes closer to the set load ratio.

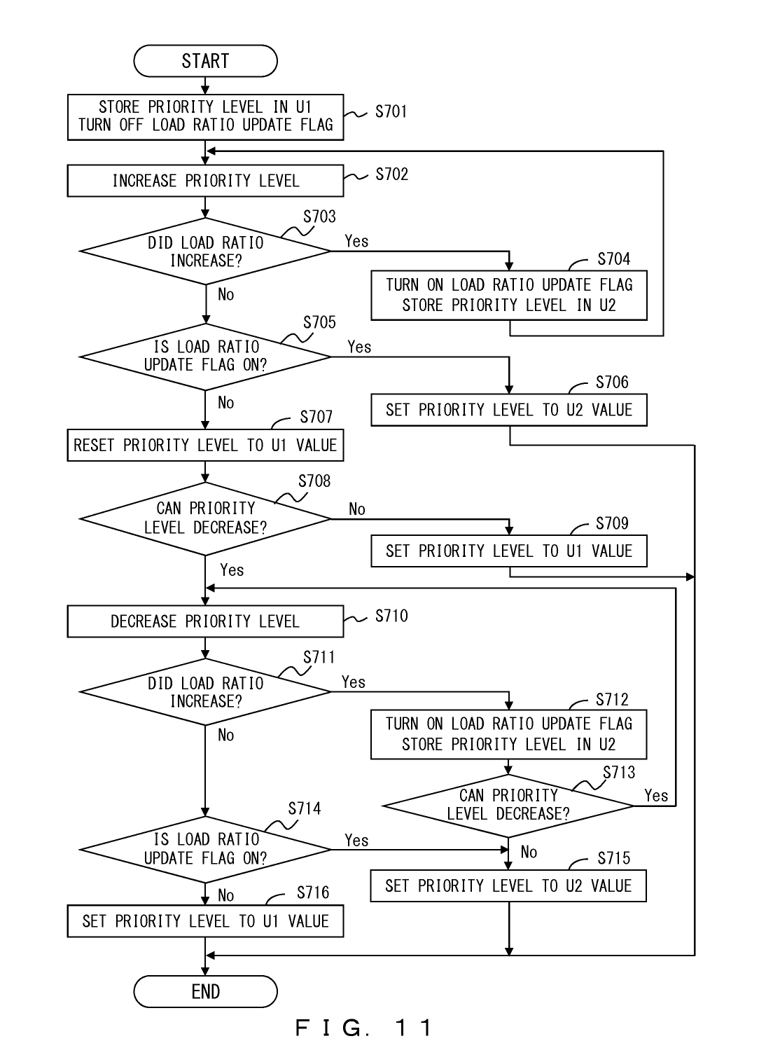

FIG. 11 is a flowchart illustrating the content of an adjustment process for a priority level.

FIG. 11 is a flowchart illustrating the content of an adjustment process for a priority level of a task in S209 illustrated in FIG. 5.

The control unit 11 stores the current priority level in U1, which is a storage area specified in the data table 23. Note that in the first adjustment process for the priority level after the start of a load test, the control unit 11 stores, in U1, the priority level stored in the initial value table 22. In the second and subsequent adjustment processes of the priority level, the priority level that was adjusted in the previous adjustment process may be stored in U1.

Then, the control unit 11 turns off the load ratio update flag stored in the data table 23 (S701).

Next, the control unit 11 sets, as a new priority level, a priority level resulting from increasing, by one step, the priority level stored in U1 (S702). In the explanations below, “U1” and “U2” respectively refer to storage areas U1 and U2 for task priority levels.

The higher the priority level newly set in S702, the higher is the priority given to the transmission/reception task executed by the testing unit 13, so that a usage time of a logical CPU longer than those given to other processes is assigned by the control unit 11 to the transmission/reception task executed by the testing unit 13.

Note that a priority level is a parameter that leads to a situation where rights to use logical CPUs are sequentially assigned to a plurality of tasks in descending order of priority level when the plurality of tasks are being executed by using logical CPUs that were sequentially assigned to port pairs. Accordingly, the higher the priority level of a task, the higher is the priority given to that task to use a logical CPU over other tasks, and that task can execute the processes with priority.

When the transmission and reception of packets have been started, the monitoring unit 12 measures the numbers of transmitted packets and received packets so as to obtain a transfer rate, which is the number of packets flowing through a LAN cable per unit time. Then, the monitoring unit 12 calculates the load ratio by dividing the transfer rate by a band that the port pair has. The control unit 11 obtains the load ratio calculated by the monitoring unit 12 and determines whether or not the change in priority level increased the load ratio (S703).

When it has been determined that the change in the priority level increased the load ratio (Yes in S703), the control unit 11 turns on the load ratio update flag stored in the data table 23 and stores a new priority level in storage area U2 (S704). Note that the priority level stored in U2 in this process is the priority level that leads to the maximum load ratio at that moment among those measured in the priority level adjustment process. Then, the control unit 11 executes the process in S702.

The load ratio update flag is a flag indicating that the load ratio has already been updated at least once in the current adjustment process for the priority level. The same flag as a load ratio update flag used for processes of other parameters may be used as the load ratio update flag, and it is also possible to store, in a different storage area in the storage device 205 for each parameter, a flag that is used independently.

When it has been determined that the change in the priority level did not increase the load ratio, the control unit 11 refers to the load ratio update flag stored in the data table 23 (S705).

When the load ratio update flag is on (Yes in S705), which means that the priority level leading to the highest load ratio is stored in U2, the control unit 11 sets the adjusted value of the priority level to the priority level stored in U2 (S706). Then, the control unit 11 terminates the adjustment process for the priority level of a task.

When the load ratio update flag is off (No in S705), the control unit 11 resets the adjusted value of the priority level to the priority level stored in U1 (S707).

In the following process, it is determined whether or not the decrease in a priority level increases the load.

The control unit 11 determines whether or not it is possible to decrease the priority level (S708). Specifically, the control unit 11 determines whether or not the lowest priority level is set as the current priority level. When the lowest priority level is set, the control unit 11 determines that it is not possible to decrease the priority level. In the example of the values stored in the initial value table 22 illustrated in FIG. 2B, the priority level is “1”.

When the priority level that is stored currently is the lowest priority level (No in S708), which means that it is not possible to decrease the priority level, the adjusted value of the priority level is set to the priority level stored in U1, i.e., priority level “1” (S709). Then, the control unit 11 terminates the adjustment process for the priority level of a task.

When the priority level is not “1”, which means that the priority level is “2” or higher, the control unit 11 sets a value resulting from decreasing the priority level by one step (S710).

Similarly to the process in S705, the control unit 11 determines whether or not increase/decrease in the number of dispatch processes increased the load ratio (S711).

When it has been determined that the decrease in the priority level increased the load ratio (Yes in S711), the control unit 11 turns on the load ratio update flag stored in the data table 23 and stores a new priority level in storage area U2 (S712).

Then, the control unit 11 determines whether or not the priority level stored in U2 in S712 is “1” (S713). When the priority level stored in U2 in S713 is not “1” (No in S713), the control unit 11 determines that it is possible to decrease the priority level further and executes the process in S710.

When the priority level is “1” (Yes in S713), which means that it is not possible to decrease the priority level further, the adjusted value of the priority level is set to the priority level stored in U2, i.e., “1” (S715). Then, the control unit 11 terminates the adjustment process for the priority level of a task.

When it has been determined that the change in the priority level did not increase the load ratio (No in S711), the control unit 11 determines whether or not the load ratio update flag is on (S714).

When the load ratio update flag is on (Yes in S714), the control unit 11 determines that an increase/decrease in the priority level does not increase the load ratio further, and executes the process in S715. Then, the control unit 11 terminates the adjustment process for the priority level of a task.

When the load ratio update flag is off (No in S714), the control unit 11 determines that an increase/decrease in the priority level did not increase the load ratio, and sets the value stored in U1 as the adjusted value of the priority level (S716). Then, the control unit 11 terminates the adjustment process for the priority level of a task.

As described above, the control unit 11 increases/decreases the priority level so as to set the priority level that leads to the maximum load ratio, as the adjusted priority level. Thereby, the information processing apparatus 100 can set the priority level that leads to the optimum load ratio. In the explanations above, an example in which the priority level that leads to the maximum load ratio is found has been used, but it is also possible to set a load ratio determined as a desirable load ratio and adjust the priority level so that the load ratio becomes closer to the set load ratio.

Also, the information processing apparatus 100 according to the embodiments sequentially adjusts a plurality of parameters whose changes in the setting lead to changes in the load ratio in descending order of influence on an increase/decrease in the load ratio so that the load ratio measured by the monitoring unit becomes closer to a determined load ratio. Thereby, the information processing apparatus 100 can set parameters in a load test more efficiently by adjusting the load ratio over a range from a rough level to a fine level.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that various changes, substitutions, and alterations could be made hereto without departing from the spirit and scope of the invention.

What is claimed is:

1. An information processing apparatus comprising:
a transmission unit configured to transmit a packet;
a reception unit configured to receive the packet; and
a processor that executes a process including:
measuring a load ratio, which is a usage rate of a band between the transmission unit and the reception unit, when the packet is being transmitted from the transmission unit to the reception unit; and
adjusting sequentially a plurality of parameters whose change in setting leads to a change in the load ratio, in descending order of influence on an increase or decrease in the load ratio so that the measured load ratio becomes closer to a determined load.

2. The information processing apparatus according to claim 1, wherein
the processor executes a process including:
changing one of the plurality of parameters when adjusting the parameters;
transmitting the packet to the reception unit via the transmission unit after changing the one parameter;
measuring a first load ratio when the packet was transmitted from the transmission unit to the reception unit;
determining whether or not the first load ratio has become closer to a determined load ratio than a measured second load ratio when the packet was transmitted to the reception unit via the transmission unit before measuring the first load ratio;
further changing the one parameter when a result of determining whether or not the first load ratio has become closer to a determined load ratio indicates that the first load ratio has become closer to a determined load ratio than the second load ratio;
setting, as an adjusted value for the one parameter, a setting value obtained when the second load ratio was measured when a result of determining whether or not the first load ratio has become closer to a determined load ratio indicates that the first load ratio has become more different from a determined load ratio than the second load ratio or when the result indicates that the first load ratio is equal to the second load ratio; and
starting changing a parameter that is next to the one parameter in influence on an increase or decrease in the load ratio.

3. The information processing apparatus according to claim 2, the information processing apparatus further comprising:
a storage unit configured to store an initial value table that stores initial values of the plurality of parameters, wherein
the plurality of parameters are parameters whose change in setting leads to a change in the load ratio, and
the processor executes a process including:
setting a setting value of the one parameter as the initial value when changing of the one parameter has been started;
transmitting the packet to the reception unit via the transmission unit;
measuring a third load ratio;
increasing the setting value after measuring the third load ratio;
transmitting the packet to the reception unit via the transmission unit;
measuring a fourth load ratio;
determining whether or not the fourth load ratio has become closer to a determined load ratio than the third load ratio;
further increasing a setting value of the one parameter and measuring the first load ratio when a result of determining whether or not the fourth load ratio has become closer to a determined load ratio indicates that the fourth load ratio has become closer to a determined load ratio than the third load ratio; and
decreasing a setting value of the one parameter from the initial value and measuring the first load ratio when a result of determining whether or not the fourth load ratio has become closer to a determined load ratio indicates that the fourth load ratio has become more different from a determined load ratio than the third load ratio or when the result indicates that the fourth load ratio is equal to the third load ratio.

4. The information processing apparatus according to claim 2, the information processing apparatus further comprising:
a storage unit configured to store an initial value table that stores initial values of the plurality of parameters, wherein
the plurality of parameters are parameters whose change in setting leads to a change in the load ratio, and
the processor executes a process including:
setting a setting value of the one parameter as the initial value and transmitting the packet to the reception unit via the transmission unit when changing of the one parameter has been started;
measuring a third load ratio;
decreasing a setting value of the one parameter from the initial value after measuring the third load ratio;
transmitting the packet to the reception unit via the transmission unit;
measuring a fourth load ratio;
determining whether or not the fourth load ratio has become closer to a determined load ratio than the third load ratio;
further decreasing a setting value of the one parameter and measuring the first load ratio when a result of determining whether or not the fourth load ratio has become closer to a determined load ratio indicates that the fourth load ratio has become closer to a determined load ratio than the third load ratio; and
increasing a setting value of the one parameter from the initial value and measuring the first load ratio when a result of determining whether or not the fourth load ratio has become closer to a determined load ratio indicates that the fourth load ratio has become more different from a determined load ratio than the third load ratio or when the result indicates that the fourth load ratio is equal to the third load ratio.

5. The information processing apparatus according to claim 3, wherein
the processor executes a process including:
setting the initial value as the second load ratio and determining whether or not the first load ratio has become closer to a determined load ratio than the second load ratio when the first load ratio has been obtained by increasing or decreasing a setting value of the one parameter from the initial value.

6. The information processing apparatus according to claim 3, wherein
the processor executes a process including:
setting the first load ratio as the second load ratio when a next first load ratio is measured after increasing a setting value of the one parameter and measuring the first load ratio;
increasing a setting value of the one parameter and measuring the next first load ratio;
setting the first load ratio as the second load ratio when a next first load ratio is measured after decreasing a setting value of the one parameter and measuring the first load ratio; and
decreasing a setting value of the one parameter and measuring the first load ratio.

7. The information processing apparatus according to claim 2, wherein
the processor executes a process including:
terminating control of adjustment of the plurality of parameters in a case where all adjusted values of the plurality of parameters have been set when changing of a parameter that is next to the one parameter in influence on an increase or decrease in the load ratio is started.

8. The information processing apparatus according to claim 3, wherein
one of the plurality of parameters is a packet count value, which represents a number of packets that are transmitted from the transmission unit to the reception unit in one packet transmission process, and
the processor executes a process including:
outputting generated packets to the transmission unit and transmitting the generated packets from the transmission unit to the reception unit each time as many packets as specified by a packet count value have been generated;
setting the packet count value to the initial value when the packet count value is adjusted;
measuring the third load ratio;
increasing or decreasing the packet count value from an initial value by a determined number after measuring the third load ratio;
measuring the fourth load ratio;
determining whether or not the fourth load ratio has become closer to a determined load ratio than the third load ratio;
decreasing a determined number by which the packet count value is increased or decreased, thereby obtaining the fourth load ratio, and determining whether or not the fourth load ratio has become closer to a determined load ratio than the third load ratio when a result of determining whether or not the fourth load ratio has become closer to a determined load ratio indicates that the fourth load ratio becomes more different from a determined load ratio than the third load ratio when the packet count value has been increased and decreased from an initial value by a determined number or when the result indicates that the third load ratio and the fourth load ratio are equal; and
setting an initial value of the packet count value as an adjusted value of the packet count value when the fourth load ratio is equal to the third load ratio even when a determined number by which the packet count value is increased or decreased is changed.

9. The information processing apparatus according to claim 8, wherein
the processor executes a process including:
setting, as a fifth packet count value, an intermediate value between a first packet count value set when the first load ratio was obtained and a second packet count value set when the second load ratio was obtained in a case when a result of determining whether or not the first load ratio has become closer to a determined load ratio indicates that the first load ratio becomes more different from a determined load ratio than the second load ratio or when the result indicates that the first load ratio is equal to the second load ratio;
transmitting the packet to the reception unit via the transmission unit;
measuring a fifth load ratio;
determining whether or not the fifth load ratio has become closer to a determined load ratio than the second load ratio when the fifth load ratio has been measured;
setting the fifth load ratio as a next second load ratio, setting the second load ratio as a next first load ratio, thereby obtaining the fifth load ratio and determining whether or not the fifth load ratio has become closer to a determined load ratio than the second load ratio when a result of determining whether or not the fifth load ratio has become closer to a determined load ratio indicates that the fifth load ratio has become closer to a determined load ratio than the second load ratio; and
setting, as an adjusted value, a setting value obtained when the second load ratio was measured in a case when a result of determining whether or not the fifth load ratio has become closer to a determined load ratio indicates that the fifth load ratio becomes more different from a determined load ratio than the second load ratio or when the result indicates that the fifth load ratio is equal to the second load ratio.

10. A load test method that is executed by a processor in an information processing apparatus, wherein
the processor executes a process including:
transmitting a packet from a transmission unit configured to transmit the packet;
receiving the packet by using a reception unit configured to receive the packet;
measuring a load ratio, which is a usage rate of a band between the transmission unit and the reception unit when the packet is being transmitted from the transmission unit to the reception unit; and
adjusting sequentially a plurality of parameters whose change in setting leads to a change in the load ratio, in descending order of influence on an increase or decrease in the load ratio so that the measured load ratio becomes closer to a determined load.
